(19) United States
(12) Patent Application Publication
(10) Pub. No.: US 2019/0194464 A1
(43) Pub. Date: Jun. 27, 2019

(54) MODIFIED DYE COMPOUNDS AND METHODS OF DYEING SUBSTRATES

(71) Applicant: VF Jeanswear LP, Greensboro, NC (US)

(72) Inventors: Sudhakar Puvvada, Cary, NC (US); Dennis Scheer, Greensboro, NC (US); Paul Gerard Hoertz, Hillsborough, NC (US)

(21) Appl. No.: 16/226,931

(22) Filed: Dec. 20, 2018

Related U.S. Application Data
(60) Provisional application No. 62/609,010, filed on Dec. 21, 2017.

(51) Int. Cl. C09B 7/10; D06P 1/30

(52) U.S. Cl. CPC C09B 7/10; D06P 1/30

(57) ABSTRACT

The present disclosure provides dye compounds for use in dyeing textiles.

### CROSS-REFERENCE TO RELATED APPLICATIONS

This application claims the priority of U.S. Provisional Patent Application No. 62/609,010, filed Dec. 21, 2017, the disclosure of which is incorporated by reference herein.

### TECHNICAL FIELD

This invention relates to modified dye compounds and methods of using them.

### BACKGROUND

Fabrics dyed with thio-indigo are desired by consumers due to the broad range of shades that can be achieved. However, the thio-indigo dyeing of yarns can be difficult process, due largely to the challenges of dyeing with the thio-indigo compound. For instance, thio-indigo has poor water-solubility in most solvents and a low affinity for fabrics.

What is needed in the art are alternate dye compounds.

### SUMMARY

The present disclosure provides dye compounds for use in dyeing substrates, the dye compounds comprising a thio-indigo derivative, or a salt thereof, having one or more modification over the chemical structure of thio-indigo, wherein the thio-indigo derivative has a water-solubility of greater than 0.2% w/v in the absence of a reducing agent and in the presence of oxygen and converts to thio-indigo upon removing the modification, wherein the chemical structure of thio-indigo is the following.

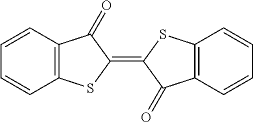 [SMILES: O=C1/C(=C2\Sc3ccccc3C2=O)Sc2ccccc21]

The present disclosure also provides compounds which are of Formula (I), (II), or a salt thereof, wherein R³—R⁴, R⁷, R⁸, n, and m are defined herein.

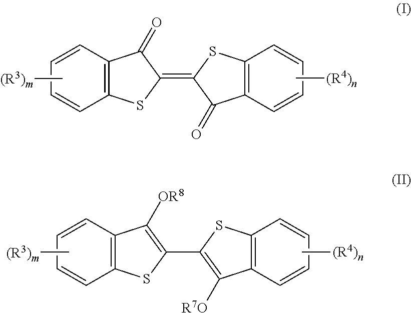

The disclosure further provides compounds of formula (I), (II), or (III) or a salt thereof, wherein X¹, X², Z¹, Z², R¹-R⁴, m, and n are defined herein.

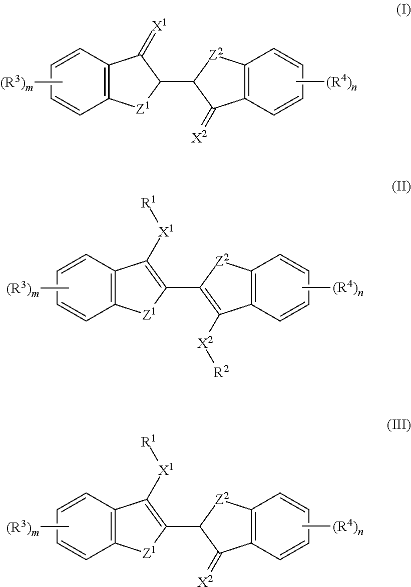

The disclosure also provides compounds of formula (I-A), (II-A), or (III-A) or a salt thereof, wherein R³, R⁴, R⁷, R⁸, m, and n are defined herein.

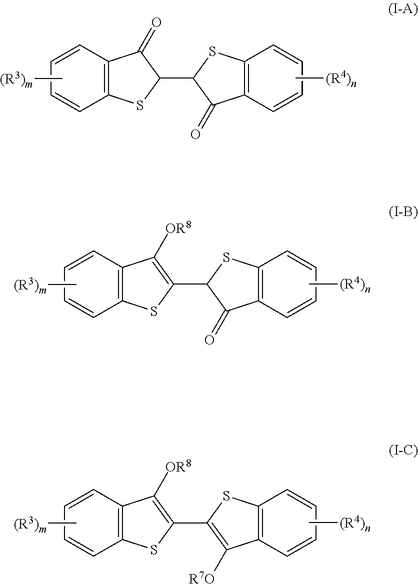

The disclosure further provides compounds of formula (II-A), (II-B), or (II-C) or a salt thereof, wherein Z¹, Z², R³, R⁴, R⁷, R⁸, m, and n are defined herein.

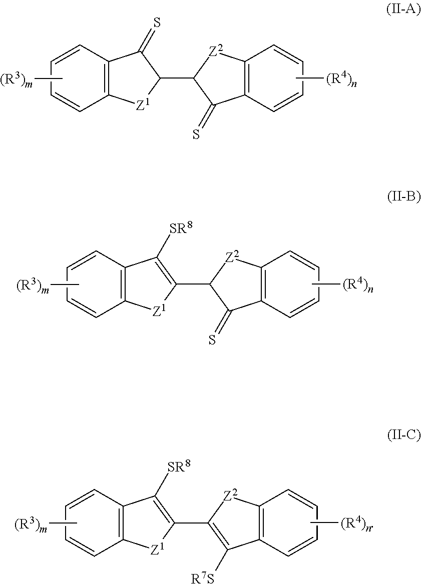

The disclosure also provides compounds of formula (III-A), (III-B), or (III-C) or a salt thereof, wherein Z¹, Z², R³, R⁴, R⁵, m, and n are defined herein.

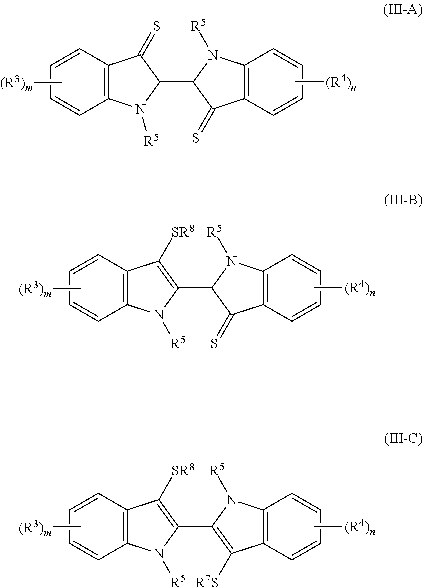

The disclosure further provides compounds of formula (IV-A), (IV-B), or (IV-C) or a salt thereof, wherein Z¹, Z², R³, R⁴, R⁷, R⁸, m, and n are defined herein.

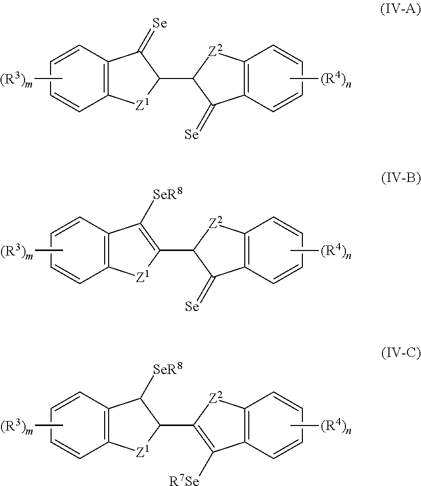

The disclosure also provides compounds of formula (V-A), (V-B), or (V-C) or a salt thereof, wherein R¹-R⁵, m, and n are defined herein.

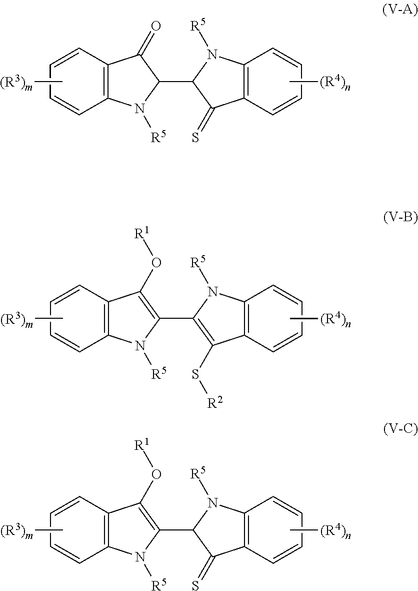

The disclosure additionally provides compounds of formula (VI-A), (VI-B), or (VI-C) or a salt thereof, wherein R¹-R⁵, m, and n are defined herein.

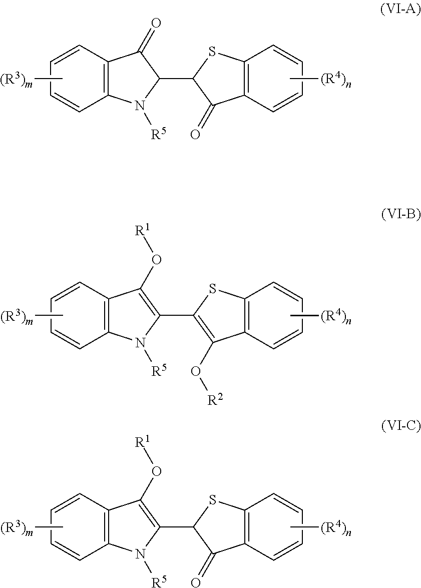

The disclosure also provides compounds of formula (VII-A), (VII-B), or (VII-C) or a salt thereof, wherein R¹-R⁵, m, and n are defined herein.

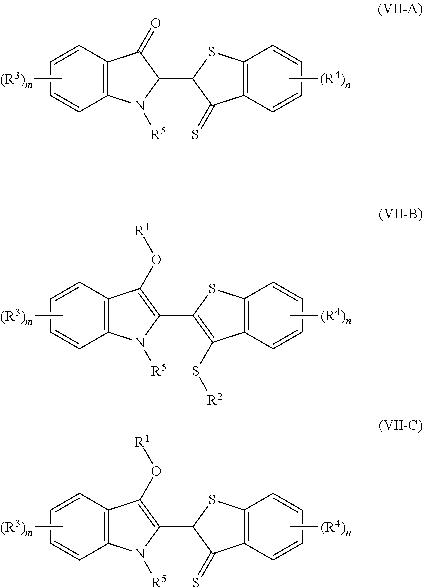

The disclosure further provides compounds of formula (VIII-A), (VIII-B), or (VIII-C) or a salt thereof, wherein R¹-R⁵, m, and n are defined herein.

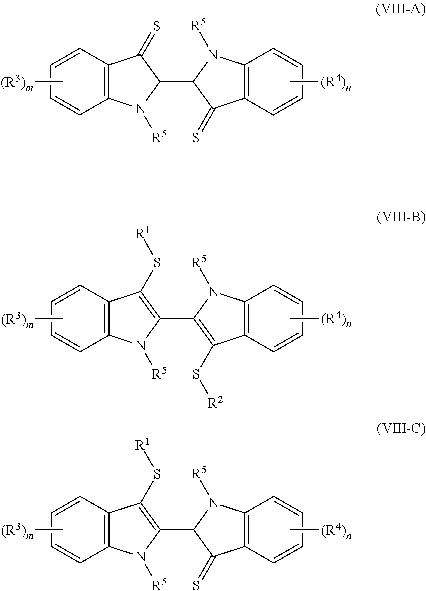

The disclosure also provides compounds of formula (IX-A), (IX-B), or (IX-C) or a salt thereof, wherein R¹-R⁵, m, and n are defined herein.

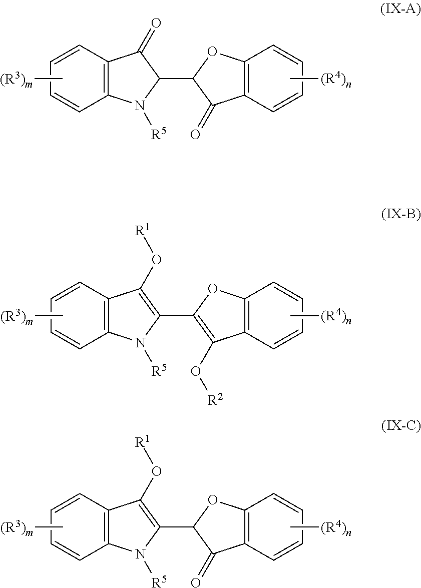

The disclosure further provides compounds of formula (X-A), (X-B), or (X-C) or a salt thereof, wherein R¹-R⁵, m, and n are defined herein.

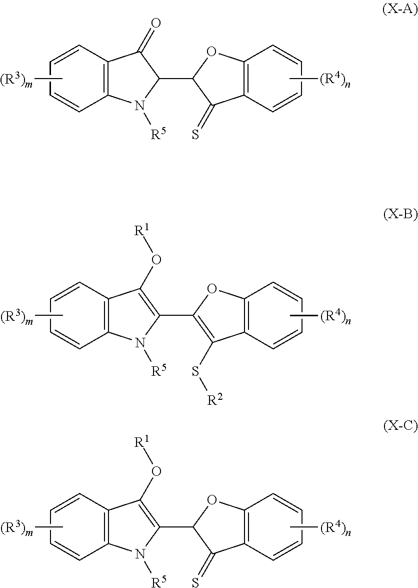

The disclosure also provides compositions comprising (i) one or more compound described herein and (ii) water.

The disclosure further provides kits comprising (i) one or more compound described herein and (ii) a reagent or device that converts the compound to thio-indigo.

The disclosure additionally provides methods of preparing a bath for dyeing a substrate, comprising mixing a compound described herein with water.

The disclosure also provides methods of dyeing a substrate, comprising (i) contacting the textile with an aqueous bath and a compound described herein and (ii) hydrolyzing the compound of step (i).

The disclosure additionally provides dyed substrates prepared according to the methods described herein.

Other aspects and embodiments of the invention will be readily apparent from the following detailed description of the invention.

### DETAILED DESCRIPTION OF ILLUSTRATIVE EMBODIMENTS

Embodiments of the present disclosure are directed to improved processes for thio-indigo dyeing a substrate, such as polyester or cotton yarn, using a modified thio-indigo compound. This process provides a number of benefits over conventional thio-indigo dyeing methods. In some embodiments, modification of thio-indigo could increase its affinity for substrates such as polyester and potentially eliminate the need for one or more of a large number of dips, the use of reducing agents in the dye bath, or the need to sky the yarn.

Preferably, this modification is environmentally friendly and atom efficient. It also is quickly and completely removable when exposed to a simple reagent or condition in order to leave standard thio-indigo on the yarn.

Accordingly, the dyeing process of embodiments of the present disclosure may be performed without the need for reducing agents in the dye bath. As such, the amount of reducing agents in the dye solution may be significantly decreased or, more preferably, the reducing agents may be eliminated from the dye solution altogether.

The oxygen stability of the modified thio-indigo compound also renders it highly advantageous for foam dyeing processes, in which the dye comes into substantial contact with the atmosphere in which the process is performed. Thus, the modified thio-indigo compounds may be applied to textile yarns through a foam dyeing process that takes place in air, i.e. without the need for an inert gas environment.

Because the modified thio-indigo compounds of the present disclosure are thought to convert to thio-indigo through hydrolysis, contact with water may cause the modified thio-indigo compounds of the present disclosure to begin to convert into water-insoluble thio-indigo. Since the dyeing process preferably comprises contacting the yarn with an aqueous solution containing the modified thio-indigo compound, stability of the modified thio-indigo compound in aqueous solution is important commercially (e.g. for maintenance of a dye bath). Notably, the modified thio-indigo compounds of the present disclosure are capable of remaining in aqueous solution for a commercially significant amount of time before substantial conversion to thio-indigo occurs.

In some embodiments, the modified thio-indigo compounds of the present disclosure remain in aqueous solution (at room temperature) for a period of at least five minutes before substantial conversion to water-insoluble thio-indigo occurs. In other embodiments, the modified thio-indigo compounds of the present disclosure remain in aqueous solution for a period of at least ten minutes before substantial conversion to water-insoluble thio-indigo occurs. In further embodiments, the modified thio-indigo compounds of the present disclosure remain in aqueous solution for a period of at least thirty minutes before substantial conversion to the water-insoluble thio-indigo compound occurs. In yet other embodiments, the modified thio-indigo compounds of the present disclosure remain in aqueous solution for a period of at least one hour before substantial conversion to water-insoluble thio-indigo occurs. In still further embodiments, the modified thio-indigo compounds of the present disclosure remain in aqueous solution for a period of at least three hours before substantial conversion to water-insoluble thio-indigo occurs. In other embodiments, the modified thio-indigo compounds of the present disclosure remain in aqueous solution for a period of at least ten hours before substantial conversion to water-insoluble thio-indigo occurs. In further embodiments, the modified thio-indigo compounds of the present disclosure remain in aqueous solution for a period of at least fifteen hours before substantial conversion to water-insoluble thio-indigo occurs. In yet other embodiments, the modified thio-indigo compounds of the present disclosure remain in aqueous solution for a period of at least twenty hours before substantial conversion to water-insoluble thio-indigo occurs. In still further embodiments, the modified thio-indigo compounds of the present disclosure remain in aqueous solution for a period of at least one day before substantial conversion to water-insoluble thio-indigo occurs. In other embodiments, the modified thio-indigo compounds of the present disclosure remain in aqueous solution for a period of at least one and one-half days before substantial conversion to water-insoluble thio-indigo occurs. In further embodiments, the modified thio-indigo compounds of the present disclosure remain in aqueous solution for a period of at least two days before substantial conversion to water-insoluble thio-indigo occurs. In still other embodiments, the modified thio-indigo compounds of the present disclosure remain in aqueous solution for a period of at least three days before substantial conversion to water-insoluble thio-indigo occurs. In yet further embodiments, the modified thio-indigo compounds of the present disclosure remain in aqueous solution for a period of at least five days before substantial conversion to water-insoluble thio-indigo occurs. In other embodiments, the modified thio-indigo compounds of the present disclosure remain in aqueous solution for a period of at least one week before substantial conversion to water-insoluble thio-indigo occurs. In further embodiments, the modified thio-indigo compounds of the present disclosure remain in aqueous solution for a period of at least ten days before substantial conversion to water-insoluble thio-indigo occurs. In still further embodiments, the modified thio-indigo compounds of the present disclosure remain in aqueous solution for a period of at least two weeks before substantial conversion to water-insoluble thio-indigo occurs. In yet other embodiments, the modified thio-indigo compounds of the present disclosure remain in aqueous solution for a period of at least three weeks before substantial conversion to water-insoluble thio-indigo occurs. In further embodiments, the modified thio-indigo compounds of the present disclosure remain in aqueous solution for a period of at least one month (i.e. 30 days) before substantial conversion to water-insoluble thio-indigo occurs.

The modified thio-indigo compounds may also be used in processes in which more thio-indigo dye can be placed on the yarn per period of contact relative to conventional dyeing methods. In this way, by using a modified thio-indigo compound of the present disclosure, one may increase the speed, and thus the output, of the process by reducing the amount of time that the yarn spends in a dye bath per dip and/or the number of dips to which the yarn is subjected. Moreover, one may obtain a darker thio-indigo dye using a relatively lower contact time and/or fewer dips than would be necessary using conventional thio-indigo dye baths. In some embodiments, for example, the concentration of the modified thio-indigo compound in an aqueous dye solution may be at least 0.3 wt. %, at least 0.5 wt. %, at least 0.6 wt. %, at least 0.8 wt. %, at least 1 wt. %, at least 2 wt. %, at least 3 wt. %, at least 5 wt. %, at least 10 wt. %, at least 15 wt. %, or at least 20 wt. %.

The improved water solubility of the modified thio-indigo compounds of the present disclosure also simplifies the process by which the dye bath is controlled, and, more particularly, by which the modified thio-indigo compound is maintained at a substantially constant concentration within the dye bath. This, in turn, minimizes the inclusion of additional chemicals, which leads to decreased costs and a lower environmental impact.

In the present disclosure the singular forms “a”, “an” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about” or “substantially” it will be understood that the particular value forms another embodiment. In general, use of the term “about” or “substantially” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about” or “substantially”. In other cases, the gradations used in a series of values may be used to determine the intended range available to the term “about” or “substantially” for each value. Where present, all ranges are inclusive and combinable. That is, references to values stated in ranges include every value within that range.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

It is to be appreciated that certain features of the invention which are, for clarity, described herein in the context of separate embodiments, may also be provided in combination in a single embodiment. That is, unless obviously incompatible or excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

### I. THE COMPOUNDS

In solving the problems in the art, the modified dye molecules described herein are likely to bond more strongly to fabrics than in the current dyeing process, are soluble in water, can be converted to thio-indigo in one simple step after dyeing, are cost effective or provide a cost saving over the current process, readily dissolve in water, unlike standard thio-indigo, and readily convert back to thio-indigo quickly and easily without skying.

The present disclosure provides dye compounds for use in dyeing substrates. The dye compounds comprise a thio-indigo derivative, or a salt thereof, having one or more modification over the chemical structure of thio-indigo. These compounds convert to thio-indigo via hydrolysis. In some embodiments, hydrolysis is accomplished using a hydrolyzing agent, heat, steam, or combinations thereof. In other embodiments, these compounds are substantially stable in the presence of an oxidant such as in aqueous solutions. In further embodiments, the compounds are substantially stable in the presence of oxygen. In other embodiments, the compounds are more stable in the air than other thio-indigo derivatives.

The term “substantially stable” refers to the ability of the compound to maintain its structure and properties thereof. In some embodiments, a compound's stability is maintained without being reduced, oxidized, or reacting with another component of the composition or method discussed herein. In other embodiments, the compound is stable since it maintains its water solubility. Desirably, less than about 50 wt. %, such as less than about 45, less than about 40, less than about 35, less than about 30, less than about 25, less than about 20, less than about 15, less than about 10, or less than about 5 wt. % of the compound in an aqueous solution degrades under atmospheric conditions over a period of about 12 hours in the absence of a reducing agent. Degradation can be measured using any analytical technique which is capable of quantifying a chemical compound including, without limitation, gas chromatography, UV-visible spectrophotometry, nuclear magnetic resonance, mass spectroscopy, or combinations thereof. In some embodiments, about 0.001 to about 50 wt. % of the compound, about 0.001 to about 45, about 0.001 to about 40, about 0.001 to about 35, about 0.001 to about 30, about 0.001 to about 25, about 0.001 to about 20, about 0.001 to about 15, about 0.001 to about 10, or about 0.001 to about 5 wt. % of the compound in an aqueous solution degrades under atmospheric conditions over a period of about 12 hours in the absence of a reducing agent. In further embodiments, 0.001 to about 5 wt. % of the compound in an aqueous solution degrades under atmospheric conditions over a period of about 12 hours in the absence of a reducing agent.

The inventors also found that the compounds described herein have greater water solubility than thio-indigo. In some embodiments, the dye compounds have a water solubility of about 0.2% w/v or greater. In preferred embodiments, the water solubility is about 0.2% w/v or greater in the absence of a reducing agent. In other preferred embodiments, the water solubility is about 0.2% w/v or greater in the presence of oxygen. In yet further embodiments, the water solubility is about 10 to about 100%, about 20 to about 100, about 30 to about 100, about 40 to about 100, about 50 to about 100, about 60 to about 100, about 70 to about 100, about 80 to about 100, about 90 to about 100, about 95 to about 100, about 98 to about 100, about 99 to about 100, or about 100 w//v. The water solubility of the compounds described herein may be measured using techniques known to those skilled in the art including, without limitation, dissolution with agitation, followed by filtration of centrifugation to isolate the soluble solids. The insoluble solids are then dried and weighed and the solubility calculated.

The term “indigo” as used herein refers to the following compound.

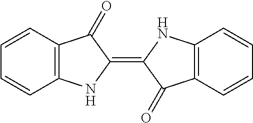 [SMILES: O=C1/C(=C2\Nc3ccccc3C2=O)Nc2ccccc21]

The term “thio-indigo” as used herein refers to the following compound.

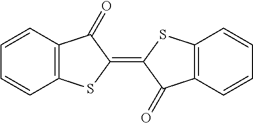 [SMILES: O=C1/C(=C2\Sc3ccccc3C2=O)Sc2ccccc21]

The term “indigo-violet” as used herein refers to the following compound.

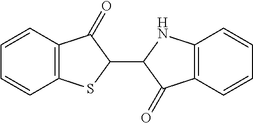 [SMILES: O=C1c2ccccc2NC1C1Sc2ccccc2C1=O]

Thus, the one or more modification is designed to enhance the aqueous solubility of the dye derivative lacking the modification. The term, “enhance” as used herein refers to improving the solubility to the dye derivative lacking the modification, improving the affinity of the thio-indigo compound to a substrate, as defined herein, providing an thio-indigo compound that converts to thio-indigo upon removing the modification, or combinations thereof. In some embodiments, the modification is removed by hydrolysis.

In some embodiments, the modification enhances the aqueous water-solubility of the thio-indigo derivative. The modification is made at any position on the thio-indigo backbone or the thio-indigo derivative. In some embodiments, one or more modification is a substituent on thio-indigo or the thio-indigo derivative. In other embodiments, the substituent is on one or more carbon atom. In yet other embodiments, the substituent is on one or both oxygen atoms. The modification may be selected by one skilled in the art and includes, without limitation, acyl, alkyl, alkoxy, amide, amine, anhydride, aryl, carbamate, CN, cycloalkyl, ester, halide, heteroaryl, heterocyclyl, imine, mesylate, NO₂, oxime, sulfonate, tosylate, or urea, wherein each substituent is optionally substituted. In some embodiments, the modification results in a thio-indigo compound which is rotationally symmetrical about an axis. In other embodiments, the modification results in a thio-indigo compound which is rotationally asymmetrical about an axis.

The term “wt. %” or “weight %” as used herein refers to the weight of the referenced compound based on the total weight of the solution. For example, the amount of Compound A in an aqueous solution contain 0.01 wt. % of Compound A is based on the based on the total weight of the components in the aqueous solution.

The term “alkyl” is used herein to refer to both straight- and branched-chain saturated aliphatic hydrocarbon groups. In one embodiment, an alkyl group has 1 to about 10 carbon atoms, i.e., C₁₋₁₀alkyl. In another embodiment, an alkyl group has 1 to about 6 carbon atoms, i.e., C₁₋₆alkyl. In a further embodiment, an alkyl group has 1 to about 4 carbon atoms, i.e., C₁₋₄alkyl. The alkyl may be unsubstituted or substituted as described herein. The substitution may be on any carbon-atom, as permitted by the stability and valency of the substituent. In some examples, the alkyl is a methyl, ethyl, propyl, butyl, pentyl, hexyl, heptyl, octyl, nonyl, or decyl.

The term “alkoxy” as used herein refers to the O-(alkyl) group, where the point of attachment is through the oxygen-atom and the alkyl group is defined above. In some examples, the alkyl is a methoxy, ethoxy, propoxy, butoxy, pentoxy, hexoxy, heptoxy, octoxy, nonoxy, or decoxy.

“Ester” refers to a —COOR group and is bound through the C-atom. R includes, but is not limited to, alkyl, cycloalkyl, aryl, heteroaryl, or heterocyclyl.

“Acyl” refers to a —C(O)R group which is bound through the C-atom. R includes, but is not limited to, alkyl, cycloalkyl, aryl, heteroaryl, or heterocyclyl.

“Carboxyl” refers to a —C(O)OH group which is bound through the C-atom.

“Amine” refers to —NH₂, —NHR, or —NR₂ which is bound through the N-atom. Each R, independently, includes, but is not limited to, alkyl, cycloalkyl, aryl, heteroaryl, or heterocyclyl.

“Amide” refers to a —C(O)NR₂ group which is bound through the C-atom. Each R, independently, includes, but is not limited to, H, alkyl, cycloalkyl, aryl, heteroaryl, or heterocyclyl.

“Sulfate” refers to a —SO₃R group which is bound through the S-atom. Each R includes, but is not limited to, H, alkyl, cycloalkyl, aryl, heteroaryl, or heterocyclyl.

“Sulfonate” refers to a —SO₂R group which is bound through the S-atom. Each R includes, but is not limited to, H, alkyl, cycloalkyl, aryl, heteroaryl, or heterocyclyl.

“Carbamate” refers to a —OC(O)NR₂ group which is bound through the 0-atom. Each R, independently, includes, but is not limited to, H, alkyl, cycloalkyl, aryl, heteroaryl, or heterocyclyl.

“Urea” refers to a —NRC(O)NR₂ group which is bound through the N-atom. Each R, independently, includes, but is not limited to, H, alkyl, cycloalkyl, aryl, heteroaryl, or heterocyclyl.

“Imine” refers to a —C(R)═NR group which is bound through the C-atom. R includes, but is not limited to, H, alkyl, cycloalkyl, aryl, heteroaryl, or heterocyclyl.

“Oxime” refers to a —C(R)═NOH group which is bound through the C-atom. R includes, but is not limited to, H, alkyl, cycloalkyl, aryl, heteroaryl, or heterocyclyl.

“Thioether” refers to a —SR group which is bound through the C-atom. R includes, but is not limited to, H, alkyl, cycloalkyl, aryl, heteroaryl, or heterocyclyl.

“Anhydride” refers to a —C(O)OC(O)R which is bound through the C-atom. R includes, but is not limited to, H, alkyl, cycloalkyl, aryl, heteroaryl, or heterocyclyl.

The term “halogen” are “halide” are used interchangeably and refer to Cl, Br, F, or I groups.

“Cycloalkyl” refers to a monocyclic or polycyclic radical that contains carbon and hydrogen, and may be saturated or partially unsaturated. In some embodiments, cycloalkyl groups include 3 to about 12 ring atoms, i.e., C₃₋₁₂cycloalkyl. In other embodiments, cycloalkyl groups include 3 to about 8 ring atoms, i.e., C₃₋₈cycloalkyl. In further embodiments, cycloalkyl groups include 5 to about 7 ring atoms, i.e., C₅₋₇cycloalkyl. Examples of cycloalkyl groups include, but are not limited to cyclopropyl, cyclobutyl, cyclopentyl, cyclopentenyl, cyclohexyl, cyclohexenyl, cycloheptyl, cyclooctyl, cyclononyl, cyclodecyl, norbornyl, and the like. The cycloalkyl may be unsubstituted or substituted as described herein. The substitution may be on any carbon-atom, as permitted by the stability and valency of the substituent.

“Heterocyclyl” refers to a saturated ring that comprises 3 to 12 carbon atom, i.e., C₃₋₁₂heterocyclyl, and from 1 to 6 heteroatoms which are nitrogen, oxygen or sulfur. The heterocyclyl is a monocyclic, bicyclic, tricyclic or tetracyclic ring, which may include fused or bridged ring systems. The heteroatoms in the heterocyclyl may be optionally oxidized. The heterocyclyl may be attached to the rest of the molecule through any atom of the ring(s). In some embodiments, the heterocyclyl has 3 to about 18 ring atoms. In some embodiments, heterocyclyl groups include 4 to about 8 ring atoms. In other embodiments, heterocyclyl groups include 5 to about 7 ring atoms. In some preferred embodiments, the heterocyclyl includes, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, monosaccharidyl such as tetrahydropyranyl (glucose), thiomorpholinyl, thiamorpholinyl, 1-oxo-thiomorpholinyl, and 1,1-dioxo-thiomorpholinyl. The heterocyclyl may be unsubstituted or substituted as described herein. The substitution may be on a carbon-atom or heteroatom, as permitted by the stability and valency of the substituent.

The term “aryl” refers to 6-15 membered monocyclic, bicyclic, or tricyclic hydrocarbon ring systems, including bridged, spiro, and/or fused ring systems, in which at least one of the rings is aromatic. An aryl group may contain 6 (i.e., phenyl) or about 9 to about 15 ring atoms, such as about 6 to about 8 ring atoms or about 9 to about 11 ring atoms. In some embodiments, aryl groups include, but are not limited to, naphthyl, indanyl, indenyl, anthryl, phenanthryl, fluorenyl, 1,2,3,4-tetrahydronaphthalenyl, 6,7,8,9-tetrahydro-5H-benzocycloheptenyl, and 6,7,8,9-tetrahydro-5H-benzocycloheptenyl. The aryl may be unsubstituted or substituted as described herein. The substitution may be on any carbon-atom, as permitted by the stability and valency of the substituent.

The term “aryloxy” as used herein refers to the O-(aryl) group, where the point of attachment is through the oxygen-atom and the aryl group is defined above. In some examples, the alkyl is a phenoxy or napthoxy.

“Heteroaryl” refers to a 5- to 18-membered unsaturated or partially unsaturated radical (e.g., C₅₋₁₃heteroaryl) that includes one or more ring heteroatoms selected from nitrogen, oxygen and sulfur. In some embodiments, the heteroaryl is monocyclic, bicyclic, tricyclic or tetracyclic. In other embodiments, the heteroatom(s) in the heteroaryl are optionally oxidized. The heteroaryl may be attached to the rest of the molecule through any atom of the ring(s). In some embodiments, the heteroaryl has 3 to about 18 ring atoms. In some embodiments, heteroaryl groups include 4 to about 8 ring atoms. In other embodiments, heteroaryl groups include 5 to about 7 ring atoms. Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzoxazolyl, benzopyranyl, benzopyranonyl, benzofuranyl, benzofuranonyl, benzofurazanyl, benzothiazolyl, benzothienyl (benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furazanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyranyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, thiapyranyl, triazolyl, tetrazolyl, triazinyl, thieno[2,3-d]pyrimidinyl, thieno[3,2-d]pyrimidinyl, thieno[2,3-c]pyridinyl, and thiophenyl (i.e. thienyl). In some embodiments, the heteroaryl is pyridyl. In other embodiments, the heteroaryl is imidazole. The heteroaryl may be unsubstituted or substituted as described herein. The substitution may be on a carbon-atom or heteroatom, as permitted by the stability and valency of the substituent. For example, one N-atom of an imidazole may be substituted. Further, any available carbon-atom may be doubly bonded to an oxygen, i.e., the carbon-atom contains an oxo (═O) group or formyl group (CH═O).

“Substituted” means that the referenced group may have one or more additional groups, radicals or moieties attached. Such groups include, independently, alkyl, cycloalkyl, aryl, heteroaryl, heterocyclyl, alkoxy, aryloxy, OH, CN, halide, NO₂, SO₃R (where R is H, halide, alkyl, aryl, cycloalkyl, heteroaryl, or heterocyclyl) such as SO₃H or SO₃Cl, C(O)OR (where R is H, alkyl, aryl, cycloalkyl, heteroaryl, or heterocyclyl), OC(O)OR (where R is H, alkyl, aryl, cycloalkyl, heteroaryl, or heterocyclyl) such as OCO₂alkyl, OC(O)R (where R is H, alkyl, aryl, cycloalkyl, heteroaryl, or heterocyclyl) such as OC(O)alkyl, PO₃R₂ (where R is H, alkyl, aryl, cycloalkyl, heteroaryl, or heterocyclyl), NR₂ (where R is H, alkyl, aryl, cycloalkyl, heteroaryl, or heterocyclyl), or a quaternary amine such as R═(CH₂)_{z}N⁺(R¹⁰)₃X⁻, wherein z is 1 or greater (such as z is 1 to 10, 1 to 5, 2 to 10, 2 to 8, or 1, 2, 3, 4, 5, 6, 7, 8, 9, or 10), R¹⁰ is H, alkyl, aryl, cycloalkyl, heteroaryl, or heterocyclyl, and X is a counteranion as described herein. Examples of R═(CH₂)_{z}N+(R¹⁰)₃X⁻ include, without limitation, R¹⁰—N(CH₃)₃, R¹⁰—N(CH₂CH₃)₃, R¹⁰—NH(CH₃)₂, R¹⁰—NH(CH₂CH₃)₂, R¹⁰—NH₂CH₃, R¹⁰—NH₂(CH₂CH₃), or R¹⁰—NH₃. The substituents themselves may be substituted, for example, a cycloalkyl substituent may itself have a halide substituent at one or more of its ring carbons. In some embodiments, the substituents noted above may be further substituted with NR₃ (where R is H, OH, alkyl, aryl, cycloalkyl, heteroaryl, or heterocyclyl) such as N(CH₃)₃ or the like. For example, the substituent may be betainyl (OC(O)CH₂N(CH₃)₃), cholinyl (OCH₂CH₂N(CH₃)₃), or carnitinyl (OC(O)CH₂CH(OH)CH₂N(CH₃)₃). The term “optionally substituted” means optional substitution with the specified groups, radicals or moieties.

As used herein, the term “counteranion” as used herein refers to an anion which balances the charge of the base molecule. In some embodiments, any anion which provides a stable salt may be selected. In other embodiments, the anion is acetate, propionate, lactate, citrate, tartrate, succinate, fumarate, maleate, malonate, mandelate, phthalate, Cl, Br, I, F, phosphate, nitrate, sulfate, methanesulfonate, ethanesulfonate, phosphonate, napthalenesulfonate, benzenesulfonate, toluenesulfonate, camphorsulfonate, methanesulfate, ethanesulfate, napthalenesulfate, benzenesulfate, toluenesulfate, camphorsulfate, bisulfate, sulfite, or bisulfite.

In other aspects, the thio-indigo compounds have an affinity to a substrate, as defined herein. The term “affinity to a substrate” as used herein refers to the ability of the dye compound to dye a substrate as described herein. In some embodiments, the affinity of the thio-indigo compounds to a textile is equal to or within a factor of about 2 to about 3 compared with thio-indigo. In some embodiments, the affinity is to a textile such as cotton. Such measurements may be made by quantifying the thio-indigo content using post-treatment methods such as sodium hydrosulfite, followed by UV-Vis spectrophotometry as described in ______, which is incorporated herein by reference.

In further aspects, the thio-indigo compounds convert to thio-indigo upon removing the modification.

Thus, in some embodiments, the compound is of Formula (I) or a salt thereof.

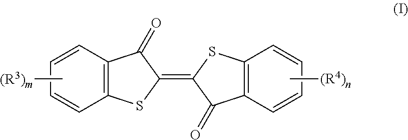

In certain embodiments, R³ and R⁴ are selected such that they do not affect the properties of the modified compound, i.e., solubility and hydrolysis to name a few. In some embodiments, R³ and R⁴ are, independently, H, halide, optionally substituted C₁₋₆alkyl, optionally substituted C₁₋₆alkoxy, SO₃H, or optionally substituted aryl. In some embodiments, R³ is halide such as Cl, Br, F, or I. In some embodiments, R⁴ is halide such as Cl, Br, F, or I. In other embodiments, R³ is C₁₋₆alkyl such as methyl, ethyl, propyl, butyl, pentyl, or hexyl. In further embodiments, R³ is C₁₋₆alkoxy, such as methoxy, ethoxy, propoxy, butoxy, pentoxy, or hexoxy. In still other embodiments, R³ is SO₃H. In yet further embodiments, R⁴ is C₁₋₆alkyl such as methyl, ethyl, propyl, butyl, pentyl, or hexyl. In other embodiments, R⁴ is C₁₋₆alkoxy, such as methoxy, ethoxy, propoxy, butoxy, pentoxy, or hexoxy. In further embodiments, R⁴ is SO₃H.

In the structure of Formula (I), m and n are, independently, 0 to 4. In some embodiments, m and n are the same. In other embodiments, m and n differ. In further embodiments, m is 0. In yet other embodiments, n is 0. In still other embodiments, m and n ar

In yet further embodiments, m and n are 2. In other embodiments, m and n are 3. In further embodiments, m and n are 4.

In other embodiments, preferred compounds encompassed by Formula (I) are the following.

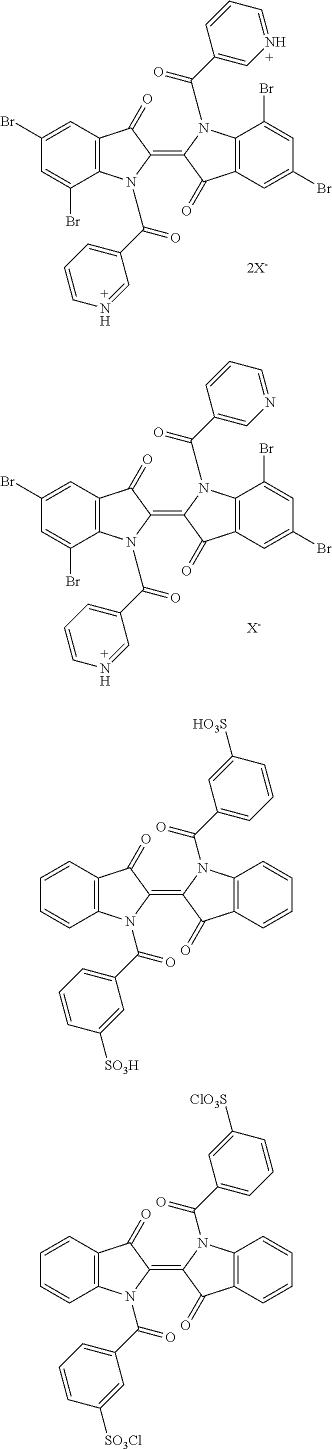

In further embodiments, the compound is of Formula (II) or a salt thereof:

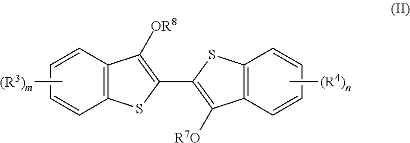

In the structure of Formula (II), R⁷ and R⁸ are not H.

In some embodiments, R³ and R⁴ are, independently, H, halide, optionally substituted C₁₋₆alkyl, optionally substituted C₁₋₆alkoxy, SO₃H, or optionally substituted aryl. In some embodiments, R³ is halide such as Cl, Br, F, or I. In some embodiments, R⁴ is halide such as Cl, Br, F, or I. In other embodiments, R³ is C₁₋₆alkyl such as methyl, ethyl, propyl, butyl, pentyl, or hexyl. In further embodiments, R³ is C₁₋₆alkoxy, such as methoxy, ethoxy, propoxy, butoxy, pentoxy, or hexoxy. In still other embodiments, R³ is SO₃H. In yet further embodiments, R⁴ is C₁₋₆alkyl such as methyl, ethyl, propyl, butyl, pentyl, or hexyl. In other embodiments, R⁴ is C₁₋₆alkoxy, such as methoxy, ethoxy, propoxy, butoxy, pentoxy, or hexoxy. In further embodiments, R⁴ is SO₃H.

In some embodiments, R⁷ and R⁸ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl). Preferably, both R⁷ and R⁸ are not SO₃H. In other embodiments, R⁷ and R⁸ are, independently, H, SO₃R^{C}, SO₂R^{C}, PO₃(R^{C})₂, C(O)NR^{A}R^{B}, C(O)-(optionally substituted C₁₋₉glycolyl), C(O)-(optionally substituted heteroaryl), C(O)-(optionally substituted heterocyclyl), C(O)-(optionally substituted C₁₋₆hydroxyalkyl), C(O)O-(optionally substituted aryl), C(O)O-(optionally substituted C₁₋₆alkyl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl).

In some embodiments, R⁷ and R⁸ are, independently, H, SO₃H, or C(O)C₁₋₆alk-C(O)C₁₋₆alkoxy. In further embodiments, R⁷ or R⁸ is H. In further embodiments, R⁷ and R⁸ are H. In other embodiments, R⁷ or R⁸ is SO₃H. In yet further embodiments, R⁷ and R⁸ are SO₃H. In still other embodiment, R₇ and R₈ are not both when both R¹ and R² are H. In further embodiments, R⁷ is C(O)C₁₋₆alk-C(O)C₁₋₆alkoxy such as C(O)CH₂C(O)CH₂CH₃. In yet other embodiments, R⁸ is H. In still further embodiments, R⁸ is SO₃H. In other embodiments, R⁷ is C(O)C₁₋₆alk-C(O)C₁₋₆alkoxy such as C(O)CH₂C(O)CH₂CH₃. In still further embodiments, one or both of R⁷ and R⁸ are C(O)(optionally substituted heteroaryl) such as C(O)(optionally substituted pyridyl).

In other embodiments, one or both of R⁷ and R⁸ are C(O)(optionally substituted C₁₋₆alkyl) such as C(O)(C₁₋₆alkyl substituted with C(O)O(C₁₋₆alkyl) such as C(O)OCH₂CH₃), C(O)-(substituted methyl), C(O)-(substituted t-butyl), C(O)-(optionally substituted ethyl), C(O)-(unsubstituted propyl), C(O)-(propyl substituted with alkyl, cycloalkyl, heteroaryl, heterocyclyl, alkoxy, aryloxy, OH, CN, or halide), C(O)-(optionally substituted n-butyl), C(O)-(optionally substituted i-butyl), C(O)-(optionally substituted pentyl), or C(O)-(optionally substituted hexyl). Thus, in this example, one of R⁷ or R⁸ is C(O)C₁₋₆alkC(O)C₁₋₆alkoxy such as C(O)CH₂C(O)OCH₂CH₃ and the other is H. In other examples, R⁷ and R⁸ is C(O)C₁₋₆alk-C(O)C₁₋₆alkoxy such as C(O)CH₂C(O)OCH₂CH₃. In further embodiments, one or both of R⁷ and R⁸ are C(O)-(optionally substituted aryl) such as C(O)-(phenyl substituted with alkyl, cycloalkyl, aryl, heteroaryl, heterocyclyl, alkoxy, aryloxy, OH, CN, or halide), C(O)-(substituted naphthyl), C(O)-(optionally substituted indanyl), C(O)-(optionally substituted indenyl), C(O)-(optionally substituted anthryl), C(O)-(optionally substituted phenanthryl), C(O)-(optionally substituted fluorenyl), C(O)-(optionally substituted 1,2,3,4-tetrahydronaphthalenyl), C(O)-(optionally substituted 6,7,8,9-tetrahydro-5H-benzocycloheptenyl), or C(O)-(optionally substituted 6,7,8,9-tetrahydro-5H-benzocycloheptenyl). For example one or both of R⁷ and R⁸ is C(O)(phenyl is substituted with CO₂H).

In the structure of Formula (II), m and n are, independently, 0 to 4. In some embodiments, m and n are the same. In other embodiments, m and n differ. In further embodiments, m is 0. In yet other embodiments, n is 0. In still other embodiments, m and n are 1. In yet further embodiments, m and n are 2. In other embodiments, m and n are 3. In further embodiments, m and n are 4.

In further embodiments, preferred compounds encompassed by Formula (II) is of Formula (II-A) or a salt thereof.

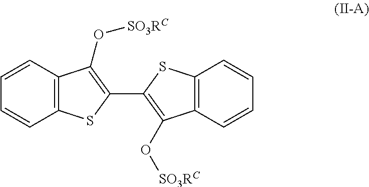

In this structure of Formula (II-A), each R^{C} is, independently, H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. In some aspects, one R^{C} is H. In further aspects, both R^{C} are H.

In some embodiments, a preferred compound encompassed by Formula (II) is the following or a salt thereof.

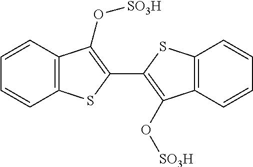 [SMILES: O=S(=O)(O)Oc1c(-c2sc3ccccc3c2OS(=O)(=O)O)sc2ccccc12]

In further embodiments, a preferred compound encompassed by Formula (II) is of Formula (II-B) or a salt thereof.

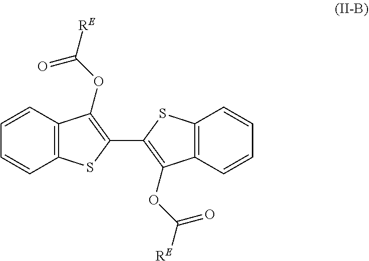

In this structure of Formula (II-B), one or both R^{E} is H, optionally substituted C₁₋₆alkyl, or optionally substituted heteroaryl, provided that both R^{E} are not H. In some aspects, one or both R^{E} is optionally substituted C₁₋₆alkyl such as C₁₋₆alkyl substituted with an ester. In other aspects, one R^{E} is optionally substituted C(O)C₁₋₆alk-C(O)C₁₋₆alkoxy such as C(O)CH₂C(O)CH₂CH₃ and the other is H. In further aspects, both R^{E} are optionally substituted C(O)C₁₋₆alk-C(O)C₁₋₆alkoxy such as C(O)CH₂C(O)CH₂CH₃. In yet other aspects, one R^{E} is H. In further aspects, one or both R^{E} is optionally substituted heteroaryl such as optionally substituted pyridyl. In yet other aspects, one or both R^{E} is substituted methyl, ethyl, propyl, n-butyl, substituted t-butyl, i-butyl, pentyl, or hexyl. In further aspects, one or both of R^{E} is substituted phenyl substituted with alkyl, cycloalkyl, aryl, heteroaryl, heterocyclyl, aryloxy, OH, CN, or halide; substituted naphthyl; optionally substituted indanyl; optionally substituted indenyl; optionally substituted anthryl; optionally substituted phenanthryl; optionally substituted fluorenyl; optionally substituted 1,2,3,4-tetrahydronaphthalenyl; optionally substituted 6,7,8,9-tetrahydro-5H-benzocycloheptenyl; or optionally substituted 6,7,8,9-tetrahydro-5H-benzocycloheptenyl.

In still other embodiments, preferred compounds encompassed by Formula (II) are the following or a salt thereof.

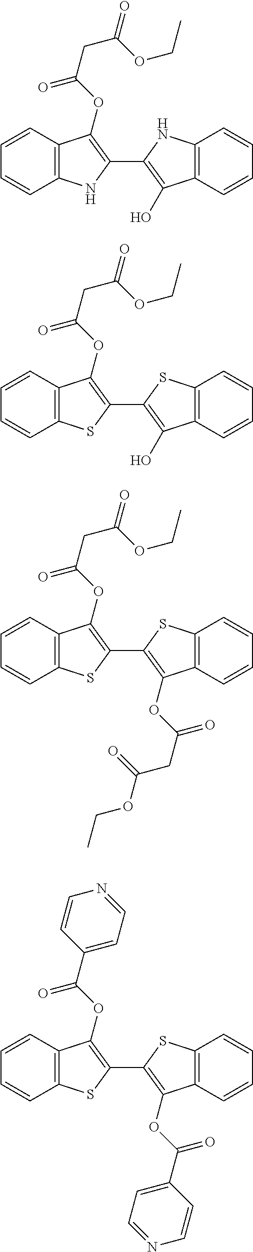

In some embodiments, the compound is of formula (I), (II), or (III) or a salt thereof:

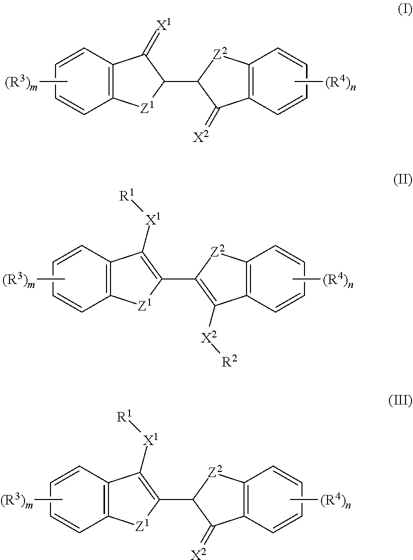

In these formulae, X¹ and X² are, independently, O, S, or Se. In one aspect, X¹ is O, S, or Se, In another aspect, X² is O, S, or Se.

Z¹ and Z² are, independently, NR⁵, S, Se, or O. In some aspects, Z¹ is independently, NR⁵, S, Se, or O. In other aspects, Z² is NR⁵, S, Se, or O

R¹, R², and R⁵ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl). R^{A} and R^{B} are, independently, H or optionally substituted C₁₋₆alkyl, or optionally substituted aryl. R^{C} is H, optionally substituted C₁₋₆alkyl, optionally substituted C₃₋₈cycloalkyl, optionally substituted aryl, optionally substituted heteroaryl, or optionally substituted heterocyclyl;

R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H.

m and n are, independently, 0 to 4.

In one embodiment, both X¹ and X² are not O when Z¹ and Z² are S.

In another embodiment, both X¹ and X² are not O when Z¹ and Z² are NR⁵.

In yet other embodiments, both X1 is O, Z¹ is NH, X² is O, and Z² is S;

In further embodiments, the compound is of formula (I-A), (I-B), or (I-C) or a salt thereof:

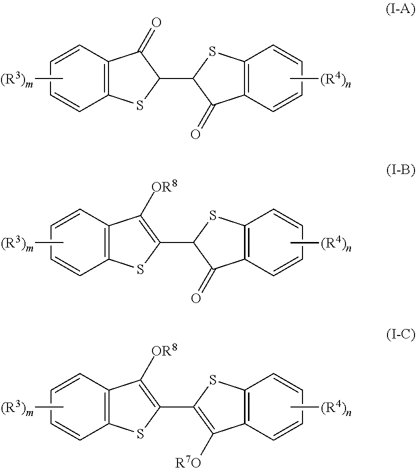

In these structures, R³ and R⁴ are, independently, H, halide, optionally substituted C₁₋₆ alkyl, optionally substituted C₁₋₆hydroxyalkyl, optionally substituted C₁₋₆alkoxy, optionally substituted aryl, or SO₃H.

R⁷ and R⁸ are, independently, H, SO₃R^{C}, SO₂R^{C}, PO₃(R^{C})₂, C(O)NR^{A}R^{B}, C(O)— (optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl). R^{A} and R^{B} are, independently, H or optionally substituted C₁₋₆alkyl, or optionally substituted aryl. R^{C} is H, optionally substituted C₁₋₆alkyl, optionally substituted C₃₋₈cycloalkyl, optionally substituted aryl, optionally substituted heteroaryl, or optionally substituted heterocyclyl;

m and n are, independently, 0 to 4.

In some embodiments in any of the above-noted structures, i.e., when the compound is of Formula (I-A), both R³ and R⁴ are not H.

In other embodiments in any of the above-noted structures, one or m or n is 0.

In further embodiments in any of the above-noted structures, R³ is a halide.

In yet other embodiments in any of the above-noted structures, R⁴ is a halide.

In still further embodiments in any of the above-noted structures, R³ is C₁₋₆alkyl.

In some embodiments in any of the above-noted structures, R⁴ is C₁₋₆alkyl.

In other embodiments in any of the above-noted structure, one or both of R⁷ and R⁸ are H.

In further embodiments in any of the above-noted structures, one of R⁷ and R⁸ are SO₃H.

In yet other embodiments in any of the above-noted structures, one or both of R⁷ and R⁸ are C(O)(optionally substituted heteroaryl) such as C(O)(optionally substituted pyridyl).

In further embodiments in any of the above-noted structures, one or both of R⁷ and R⁸ are C(O)(optionally substituted C₁₋₆alkyl).

In other embodiments in any of the above-noted structures, the C₁₋₆alkyl is substituted with C(O)O(C₁₋₆alkyl) such as C(O)OCH₂CH₃.

In yet further embodiments in any of the above-noted structures, one or both of R⁷ and R⁸ are C(O)-(optionally substituted aryl) such as C(O)-(optionally substituted phenyl).

In still other embodiments in any of the above-noted structures, the phenyl is substituted with CO₂H.

In some embodiments, preferred compounds are of formula (II-A), (II-B), or (II-C) or a salt thereof:

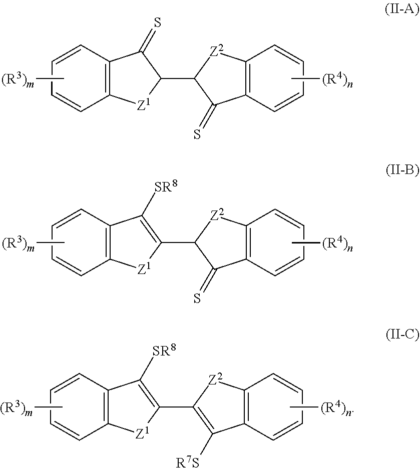

In other embodiments, preferred compounds are of formula (III-A), (III-B), or (III-C) or a salt thereof:

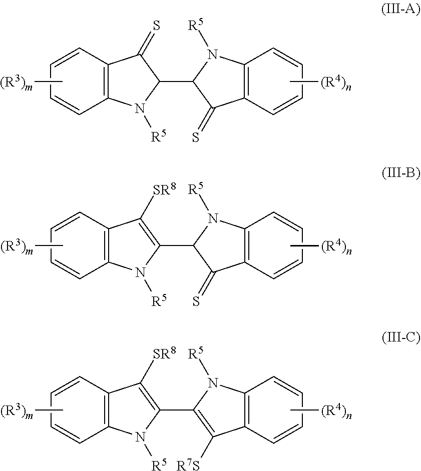

In further embodiments, preferred compounds are of formula (IV-A), (IV-B), or (IV-C) or a salt thereof:

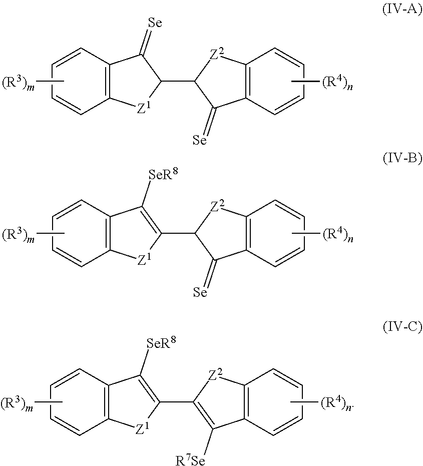

In still other embodiments, preferred compounds are of formula (V-A), (I-B), or (V-C) or a salt thereof:

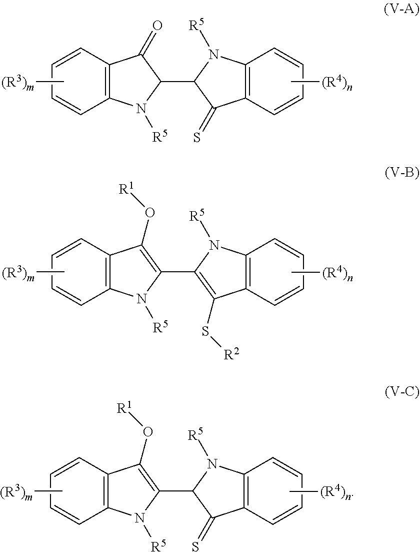

In yet further embodiments, preferred compounds are of formula (VI-A), (VI-B), or (VI-C):

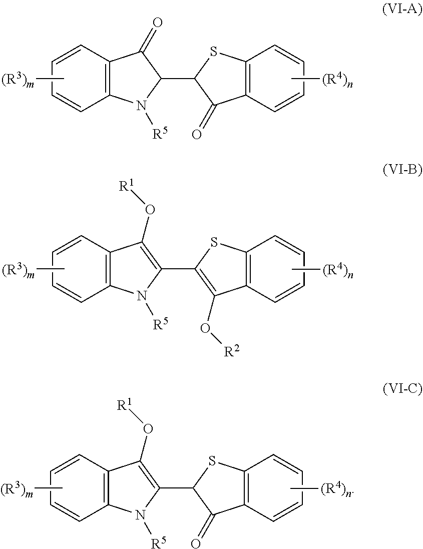

In other embodiments, preferred compounds are of formula (VII-A), (VII-B), or (VII-C):

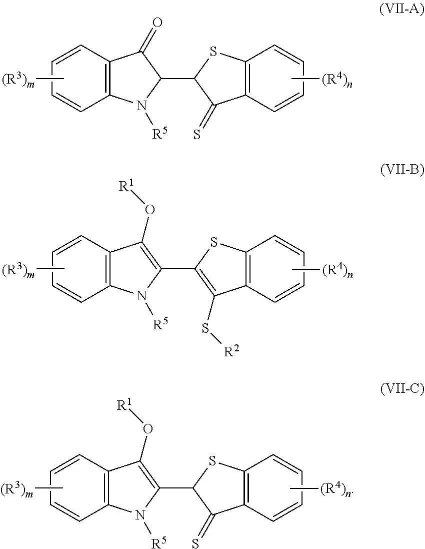

In further embodiments, preferred compounds are is of formula (VIII-A), (VIII-B), or (VIII-C):

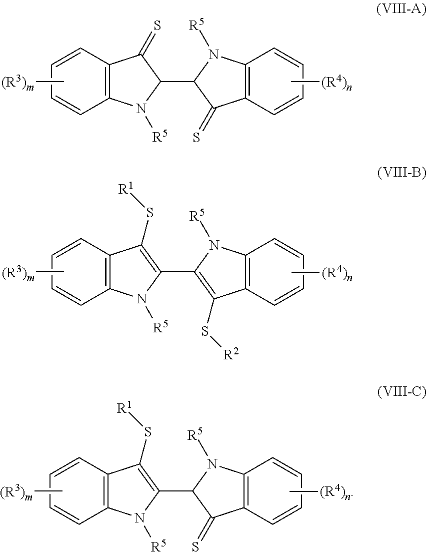

In other embodiments, preferred compounds are of formula (IX-A), (IX-B), or (IX-C):

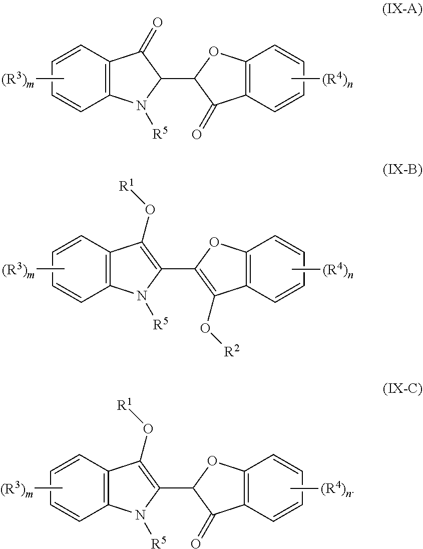

In further embodiments, preferred compounds are is of formula (X-A), (X-B), or (X-C):

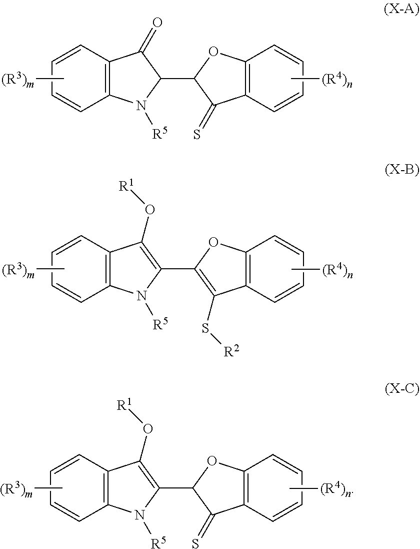

The compounds discussed above may also be used in the form of salts derived from acceptable acids, bases, alkali metals and alkaline earth metals. Thus, the compounds described herein may exist as the free base or a salt thereof. Preferably, the salts are formed via ionic interactions, covalent interactions, or combinations thereof. For example, the salts may be formed by alkylating a heteroatom such as a N-atom within the compound and having a counteranion ionically bound to the heteroatom. The counteranion may be selected by those skilled in the art and includes those anions from the acids identified above and below.

The salts can be formed from organic and inorganic acids including, e.g., carboxylic acids such as acetic, propionic, lactic, citric, tartaric, succinic, fumaric, maleic, malic, malonic, mandelic, and phthalic acids, hydrochloric (Cl⁻), hydrobromic (Br⁻), hydroiodic (I⁻), hydrofluoric (F⁻), phosphoric, nitric, sulfuric, methanesulfonic, phosphoric, napthalenesulfonic, benzenesulfonic, toluenesulfonic, camphorsulfonic, and similarly known acceptable acids. In some embodiments, the salt is a sulfate salt, alkylsulfate salt, bisulfate salt, phosphate salt, halide salt, sulfite salt, or bisulfite salt. In further embodiments, the compounds are a sulfate salt. In other embodiments, the compound exists as an alkylsulfate salt such as a methylsulfate or ethylsulfate salt. In further embodiments, the compound exists as a halide salt such as an iodide salt, chloride salt, bromide salt, or fluoride salt. In other embodiments, the compound exists as a bisulfate salt. In yet further embodiments, the compound exists as a phosphate salt.

In other embodiments, salts may also be formed from inorganic bases, desirably alkali metal salts including, e.g., sodium, lithium, or potassium, such as alkali metal hydroxides. Examples of inorganic bases include, without limitation, sodium hydroxide, potassium hydroxide, calcium hydroxide, and magnesium hydroxide.

Salts may also be formed from organic bases, such as ammonium salts, mono-, di-, and trimethylammonium, mono-, di- and triethylammonium, mono-, di- and tripropylammonium, ethyldimethylammonium, benzyldimethylammonium, cyclohexylammonium, benzyl-ammonium, dibenzylammonium, piperidinium, morpholinium, pyrrolidinium, piperazinium, 1-methylpiperidinium, 4-ethylmorpholinium, 1-isopropylpyrrolidinium, 1,4-dimethylpiperazinium, 1 n-butyl piperidinium, 2-methylpiperidinium, 1-ethyl-2-methylpiperidinium, mono-, di- and triethanolammonium, ethyl diethanolammonium, n-butylmonoethanolammonium, tris(hydroxymethyl)methylammonium, phenylmono-ethanol ammonium, diethanolamine, ethylenediamine, choline, betaine, carnitine, and the like. In one example, the base is selected from among sodium hydroxide, lithium hydroxide, potassium hydroxide, and mixtures thereof.

The compounds discussed herein may also encompass tautomeric forms of the structures provided herein, where such forms may be formed.

### II. METHODS OF PRODUCTION

The compounds described above may be prepared by known chemical synthesis techniques. Among such preferred techniques known to one of skill in the art are included the synthetic methods described in conventional textbooks relating to the construction of synthetic compounds.

In some embodiments, it may be desirable to dry the modified thio-indigo compound at the conclusion of this process, so as to remove all or substantially all of the water. In doing so, one may prepare a powder comprising the modified thio-indigo compound. This powder may be easily shipped and stored and will not convert to thio-indigo during shipping and/or storage. Moreover, the powder may easily be dissolved at the mill to form the dye. Alternatively, the modified thio-indigo compound may be added to a non-aqueous solvent for shipping and/or storage.

### III. COMPOSITIONS CONTAINING THE COMPOUND

Compositions useful herein, in one embodiment, contain a compound discussed above in a diluent. The term “diluent” as used herein refers to a liquid compound that is capable of solubilizing some or all of the compounds discussed herein. In some embodiments, the diluent is water. In other embodiments, the diluent contains water and an organic solvent such as low vapor pressure organic solvents. In further embodiments, the diluent contains an organic solvent. Examples of organic solvents include, without limitation, glycols such as diethylene glycol monomethyl ether, triethylene glycol monomethyl ether, diethylene glycol monoethyl ether, triethylene glycol monoethyl ether, propylene glycol, alcohols such as glycerol, ketones, amines, or combinations thereof.

The compositions may also include optional suitable inert or inactive ingredients that are useful in compositions for dyeing substrates. The compositions may further include standard dyeing chemicals such as those described in Denim, Manufacture, Finishing and Applications, 1st Edition, Ed.: Roshan Paul, Woodhead Publishing, Apr. 23, 2015; Handbook of Textile and Industrial Dyeing, Principles, Processes and Types of Dyes, 1st Edition, Ed.: M. Clark, Woodhead Publishing, Oct. 25, 2011; and Handbook of Textile and Industrial Dyeing, Volume 2: Applications of Dyes, 1st Edition, Ed.: M. Clark, Woodhead Publishing, Oct. 25, 2011, all of which are incorporated herein by reference.

In some embodiments, the standard dyeing chemicals prepare the substrate for dyeing, i.e., a pretreating step. In other embodiments, the standard dyeing chemicals are useful in the step of dyeing the substrate. In further embodiments, the standard dyeing chemicals are useful in dyeing denim. In yet other embodiments, the standard dyeing chemicals are useful after dyeing is complete, i.e., a post-treating step such as a hydrolyzing step, neutralizing step, or a rinsing step. These compounds include, without limitation, one or more of an acid, cationic agent, chelating agent, color retention agent, coloring agent, dispersant, foaming agent, mercerization reagent, penetration enhancer, pH buffering agent, salt, stabilizing agent, solubilizing agent, surfactant, thickening agent, tracer, viscosity modifier, or wetting agent. One of skill in the art would be able to determine if a standard dyeing chemical may be used before, during, or after dyeing the substrate.

In other embodiments, the composition contains a cationic agent. In some embodiments the cationic agent is an ammonium salt such as diallyldimethylammonium chloride, polymerized diallyldimethylammonium chloride, [2-(acryloyloxy)ethyl]trimethylammonium chloride, 3-chloro-2-hydroxylpropyl trimethyl-ammonium chloride, or combinations thereof.

The composition may further comprise a solubilizing agent. In some embodiments, the solubilizing is an organic solvent, surfactant, or emulsifier. In other embodiments, the organic solvent is a low vapor pressure organic solvent. Examples of organic solvents include, without limitation, diethylene glycol monomethyl ether, triethylene glycol monomethyl ether, diethylene glycol monoethyl ether, triethylene glycol monoethyl ether, propylene glycol, glycerol, or combinations thereof. In further embodiments, the surfactant is glyceryl monostearate, polyoxoethylated castor oil, polysorbates such as the Tween® surfactants, sodium lauryl sulfate, sodium dodecyl sulfate, sorbitan esters such as the Span® or Arlacel™ surfactants, stearyl alcohols, cetyl alcohols, triethanolamine, or the Triton™ X-100 surfactant, among others.

The composition may also contain a stabilizing agent. Such agents may be selected by those skilled in the art and include, without limitation, NaCl, Na₂SO₄, a surfactant, or combinations thereof. In some embodiments, the surfactant is glyceryl monostearate, polyoxoethylated castor oil, polysorbates such as the Tween® surfactants, sodium lauryl sulfate, sodium dodecyl sulfate, sorbitan esters such as the Span® or Arlacel™ surfactants, stearyl alcohols, cetyl alcohols, triethanolamine, or the Triton™ X-100 surfactant, among others

### IV. METHODS OF USING THE COMPOUNDS

The methods of dyeing described herein are practical and feasible. Thus, the thio-indigo dyeing methods reduce cost, increase throughput and improve the sustainability of the denim-dyeing process. In fact, the compounds discussed herein may be utilized in existing plants in place of the currently utilized thioindigo methods with little to no change required for the mechanical equipment. The dyeing methods and techniques described herein may selected by those skilled in the art including those recited in Denim, Manufacture, Finishing and Applications, 1st Edition, Ed.: Roshan Paul, Woodhead Publishing, Apr. 23, 2015; Handbook of Textile and Industrial Dyeing, Principles, Processes and Types of Dyes, 1st Edition, Ed.: M. Clark, Woodhead Publishing, Oct. 25, 2011; and Handbook of Textile and Industrial Dyeing, Volume 2: Applications of Dyes, 1st Edition, Ed.: M. Clark, Woodhead Publishing, Oct. 25, 2011, which are herein incorporated by reference.

In some embodiments of the present disclosure, the process of thio-indigo dyeing with a modified thio-indigo compound involves two basic steps. In a first step, a substrate such as a textile yarn is contacted with a dye solution that contains a modified thio-indigo compound. As a result of this contact, the substrate takes up an amount of the modified thio-indigo compound. For example, when a cotton yarn is contacted with the dye solution, the dye solution both coats a surface of the yarn and penetrates some distance below the surface of the yarn. The amount of dye solution contained within the resulting yarn may be controlled by controlling the duration of the contact and the concentration of modified thio-indigo in the dye solution. When the substrate has been contacted so as to contain a desired amount of dye solution, the dye-treated substrate is brought out of contact with the dye solution.

The methods are useful in dyeing a substrate by contacting one or more compound described herein with the substrate. The term “substrate” as used herein refers to a material that may be dyed using the compounds described herein. The substrate contains natural substrates, synthetic substrates, or combinations thereof. In some embodiments, the substrate is natural. In other embodiments, the substrate is synthetic. In further embodiments, the substrate contains natural and synthetic components. The natural substrate may be selected by those skilled in the art from, without limitation, plant or animal substrates. Plant fibers include cotton, kapok, hemp, bamboo, flax, sisal, jute, kenaf, ramie, bamboo, soybean, or coconut, among others. Animal substrates include silk, wool, leather, hair, feather, among others. In some embodiments, the animal substrate is silk, wool, leather, or feather. In other embodiments, the substrate comprises a synthetic fiber such as a synthetic polymer. The synthetic substrate may be prepared using viscose or lyocel processes, preferably or from regenerated/spun cellulose processes. Thus, the synthetic substrate includes, without limitation, rayon such as lyocel (TENCEL®), a polyamide such as nylon, polyester, polyacrylate, polyolefin, or spandex. In some embodiments, the synthetic substrate is a polyamide such as nylon. In other embodiments, the polyester is polyethylene terephthalate. In further embodiments, the polyolefin is polypropylene or polyethylene. In still other embodiments, the polyacrylate is a copolymer of polyacrylonitrile. In contrast to the methods used in the art for dyeing synthetic substrates, the methods described herein do not require heating the substrate, e.g., to the substrate's T_{g}, during the dyeing process.

While the present disclosure is primarily described in relation to the dyeing of cotton yarn, it should be understood that the modified thio-indigo compounds and dyeing processes disclosed herein may also be used to dye any number of different textile materials, including without limitation fibers comprising cellulosic material, such as silk, wool, rayon, lyocel, flax, linen, ramie, and the like, as well as materials comprising combinations thereof.

The substrate may be in any physical form or shape that permits dyeing by the compounds described herein. Thus, the substrate may be a single fiber or a number of fibers gathered together in another form. In some embodiments, the substrate is in the form of a yarn, sheet, or package. In other embodiments, the substrate is a yarn. In further embodiments, the substrate is a package. In other embodiments, the substrate is a fabric. The yarns may be fitted together to form sheets or packages of yarns such as a carpet. Similarly, the fibers may be woven to form a sheet such as a textile. In some embodiments, the dye substrate or textile is denim. In further embodiments, the substrate is a fabric or textile such as clothing or garment.

As used herein, the term “yarn” should be understood as meaning a length of interlocked textile fibers or filaments that is suitable for the production of fabrics. In some embodiments, thio-indigo-dyeing is performed on yarn or ropes of yarn. In other embodiments, the yarn is converted to packages, which can be used in weaving or knitting operations. For example, thio-indigo-dyed yarn is often weaved into denim fabric, and more specifically this dyed yarn is then used as the warp yarn in a denim fabric weave. However, in some processes the yarn may be weaved into a fabric, such as through a denim weave, and then dyed. Accordingly, unless specified, the term yarn should be understood herein as inclusively referring to any of individual yarns, ropes of yarn, packages of yarn, sheets of yarn, and yarn that is present in a fabric.

Moreover, as used herein, the term “cotton yarn” should be understood as any yarn containing cotton fibers. In some embodiments, the cotton yarn may contain 100% cotton fibers. In other embodiments, the cotton yarn may contain a mixture of cotton fibers and other natural or synthetic fibers/filaments. For example, the cotton yarn may contain a blend of cotton and polyester, nylon, elastomeric materials such as elastane (i.e. spandex), or mixtures thereof. Additionally, in some embodiments, a portion of the cotton or all of the cotton may be treated. For example, in some embodiments at least a portion of the cotton may be treated so as to render the cotton hydrophobic. Accordingly, unless specified, the term cotton yarn should be understood herein as inclusively referring to any yarn that contains cotton fibers, including mixtures of cotton and other materials.

The term “contacting” as used herein refers to any route by which the substrate is contacted with the dye compound. In some embodiments, the substrate is contacted directly with the compound in the absence of a diluent. In other embodiments, the substrate is contacted with a composition comprising the dye compound. In further embodiments, the substrate is contacted with an aqueous bath comprising the dye compound. In yet other embodiments, the substrate is dipped into an aqueous bath comprising the dye compound. In still further embodiments, the dye compound is in the form of a foam and the foam is applied to the substrate for example by spraying the substrate with the foam. For example, techniques such as dip dyeing, rope dyeing, slasher dyeing, spray dyeing, continuous dyeing, piece dyeing, space dyeing, package dyeing, skein dyeing, garment dyeing, paint brush dyeing, airbrush dyeing, blotch dyeing, or foam dyeing may be utilized to contact the substrate with the dye compound.

Advantageously, the bath containing the dye compound lacks a reducing agent to convert the compound to a leuco form of the compound. In other embodiments, the bath containing the dye compound lacks an alkali agent. In further embodiments, the bath containing the dye compound lacks a reducing agent which is sodium hydrosulfite formamidine sulfinic acid, glucose, sodium borohydride, sodium metabisulfite, thiourea dioxide cellobiose, glyceraldehyde, or fructose.

When an aqueous bath is utilized to dye the substrate, it is prepared by mixing one or more compound with water. In some embodiments, each bath comprises about 0.5 wt. % to about 70 wt. %, based on the weight of the bath, of the compound. In other embodiments, the bath comprises about 1 wt. % to about 50 wt. %, based on the weight of the bath, of the compound. In further embodiments, the bath comprises about 2 wt. % to about 30 wt. %, based on the weight of the bath, of the compound. In still other embodiments, the bath contains about 5 to about 25 wt. %, based on the weight of the bath, of the compound. In yet further embodiments, the bath contains about 10 to about 20 wt. %, based on the weight of the bath, of the compound. In other embodiments, the bath contains about 12 to about 18 wt. %, based on the weight of the bath, of the compound. In further embodiments, the bath contains about 14 to about 16 wt. %, based on the weight of the bath, of the compound. Preferably, the bath contains about 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt. %, based on the weight of the bath, of the compound. More preferably, each bath contains about 1 to about 3 wt. % to about 70 wt. %, based on the weight of the bath, of the compound. Even more preferably, each bath contains about 2 wt. % to about 70 wt. %, based on the weight of the bath, of the compound.

In addition to the compound and water, the aqueous bath may contain other additional components such as those described above for compositions containing the compound. These compounds include, without limitation, an acid, cationic agent, caustic agent, chelating agent, color retention agent, coloring agent, dispersant, foaming agent, hydrolyzing agent, mercerization reagent, penetration enhancer, pH buffering agent, salt, solubilizing agent, stabilizing agent, surfactant, thickening agent, tracer, viscosity modifier, wetting agent, or combinations thereof. One of skill in the art would be able to determine if a standard dyeing chemical may be used before, during, or after dyeing the substrate. In some embodiments, the aqueous bath lacks a solubilizing agent. In other embodiments, the aqueous bath contains solubilizing agent. In further embodiments, the aqueous bath is acidic, i.e., has a pH of less than about 7. In some embodiments, the aqueous bath as a pH of about 0.5 to about 7, about 1 to about 7, about 1 to about 6, about 1 to about 5, about 1 to about 4, about 1 to about 3, about 1 to about 2, about 1, about 2, about 3, about 4, about 5, about 6, or about 6.

The substrate is kept in contact with the aqueous solution, i.e., dyed, for a time sufficient so as to dye the substrate. In some embodiments, the time is dependent on the extent of dye that penetrates the substrate. In other embodiment, the time is dependent on the desired color of the substrate is achieved. In further embodiments, the time is dependent on the concentration of the dye being applied to the substrate. In yet other embodiments, the substrate is kept in contact with the aqueous solution for about 5 seconds to about 10 hours. In still further embodiments, the substrate is kept in contact with the dye compound for about 5, 10, 20, 30, or 45 seconds, 1, 2, 3, 4, 5, 6, 7, 8, 9, 10, 15, 30, or 45 minutes, or 1, 2, 3, 4, 5, 6, 7, 8, 9, or 10 hours.

The substrate also is kept in contact with the aqueous solution at a suitable temperature. In some embodiments, the dyeing temperature is any temperature that does not degrade any components of the dyeing process. In some embodiments, the temperature is ambient temperature. In other embodiments, the temperature is about 20 to about 40° C., such as about 10 to about 35° C., or about room temperature.

In another step, the modified thio-indigo compound that has been taken up by the dye-treated substrate is converted to thio-indigo through a process of hydrolysis. In some embodiments, the substrate is contacted with a hydrolyzing agent, the hydrolyzing agent being capable of reacting with the modified thio-indigo compound contained within the substrate to convert the modified thio-indigo compound into thio-indigo. For example, when a cotton yarn that has been contacted with a dye solution is then contacted with an appropriate hydrolyzing agent, the modified thio-indigo contained within the cotton yarn is converted to thio-indigo, thereby producing a thio-indigo-dyed yarn.

In some embodiments, the substrate may be contacted with an alkali agent in order to hydrolyze the modified thio-indigo compound so as to convert it into thio-indigo. The contacting of the substrate with the alkali hydrolyzing agent may be performed in a number of different manners. For instance, the substrate may be dipped in a solution containing the alkali agent, e.g. an aqueous hydrolyzing bath, or a solution containing the alkali agent may be sprayed onto the substrate. By converting the modified thio-indigo compound into thio-indigo, a thio-indigo-dyed substrate is produced.

In many dyeing processes, multiple iterations of this two-step process will be necessary in order to obtain a desirable shade of thio-indigo. Accordingly, in many dyeing processes, once the modified thio-indigo compound on the substrate is converted into thio-indigo, the substrate will again be contacted with dye solution containing a modified thio-indigo compound. In some embodiments, substrate is contacted with the same bath that was used to as the initial dye bath. In other embodiments, the substrate is contacted with another dye bath containing the same or a different amount of the dye compound. One of skill in the art would be able to determine how many instances it is necessary to contact the substrate with the dye compound. For example, one skilled in the art would be able to determine how many times to dip the substrate into the dye bath. See, for example, Denim, Manufacture, Finishing and Applications, 1st Edition, Ed.: Roshan Paul, Woodhead Publishing, Apr. 23, 2015; Handbook of Textile and Industrial Dyeing, Principles, Processes and Types of Dyes, 1st Edition, Ed.: M. Clark, Woodhead Publishing, Oct. 25, 2011; and Handbook of Textile and Industrial Dyeing, Volume 2: Applications of Dyes, 1st Edition, Ed.: M. Clark, Woodhead Publishing, Oct. 25, 2011, all of which are incorporated herein by reference for these teachings. Although the substrate may only require contacting it once with the dye compound, the substrate typically is contacted with the dye compound at least two times. In some embodiments, the dye compound is contacted about 4 to about 25 times, about 5 to about 20 times, about 6 to about 18 times, about 7 to about 16 times, about 8 to about 14 times, about 8 to about 12 times, about 8 to 10 times, about 9 to 16 times, about 9 to about 14 times, about 9 to about 12 times, about 12 to about 18 times, about 12 to about 16 times, 1 to about 25 times, 2 to about 20 times, about 3 to about 18 times, about 4 to about 16 times, about 5 to about 15 times, about 5 to about 12 times, about 5 to about 10 times, about 5 to about 8 times, or any other ranges there between.

A further step includes hydrolyzing the dye compound in the dyed substrate to thio-indigo. In some embodiments, hydrolysis of the dye compound is performed with a solution which contains water. In other embodiments, hydrolysis is performed with water. The water can be from a fresh source or may be reused. Thus, the water can contain other components including, without limitation, an acid, cationic agent, chelating agent color retention agent, coloring agent, dispersant, foaming agent, mercerization reagent, organic solvent, pH buffering agent, penetration enhancer, salt, stabilizing agent, solubilizing agent, surfactant, thickening agent, tracer, viscosity modifier, or wetting agent. In some embodiments, the rinse water contains an acid, cationic agent, chelating agent, dispersant, foaming agent, organic solvent, pH buffering agent, penetration enhancer, salt, solubilizing agent, surfactant, thickening agent, tracer, viscosity modifier, or wetting agent.

The hydrolysis is performed using any chemical compound or condition that is capable of converting the dye compound to thio-indigo. In some embodiments, the hydrolysis is performed in aqueous compositions which contain a hydrolyzing agent. In other embodiments, the hydrolyzing agent may be selected by one skilled in the art and may include, without limitation, a base, heat, steam, or a combination thereof.

In some embodiments, the hydrolyzing agent is an alkali agent. Preferably, the alkali agent ensures that the pH of the hydrolysis is raised to greater than about 11. For example, the base is an oxide, hydroxide of alkali metals or alkaline earth metal, or carbonate of an alkali or alkaline earth metal. In some embodiments, the hydrolysis is performed with an oxide. In other embodiments, the hydrolysis is performed with a hydroxide of an alkali metal such as sodium hydroxide, potassium hydroxide, or lithium hydroxide. In further embodiments, the hydrolysis is performed with a carbonate such as sodium carbonate or potassium carbonate. In still other embodiments, the hydrolysis is performed with a hydroxide of an alkaline earth metal.

The hydrolysis may also be performed using an elevated temperature. Thus, in some embodiments, the hydrolysis may be performed using heat such as by contacting the dyed substrate with a heat plate or blowing hot air on the dyed substrate. One skilled in the art would be able to select a suitable temperature for use in the hydrolysis of the dye compound. For example, the heat comprises a temperature of at least about 80° C. In some embodiments, the heat comprises a temperature of about 80 to about 200° C., such as about 100 to about 200° C., about 120 to about 200° C., about 150 to about 200° C., about 180 to about 200° C., about 80 to about 100° C., about 80 to about 120° C., about 80 to about 140° C., about 80 to about 160° C., about 80 to about 180° C., or about 80, 90, 100, 110, 120, 130, 140, 150, 160, 170, 180, 190, or about 200° C.

Similarly, steam may be used to effect the hydrolysis. In some embodiments, steam is sprayed onto the dyed substrate or the dyed substrate is passed through a unit comprising an atmosphere of steam. The temperature of the steam is desirably at a temperature recited above.

After the hydrolysis is complete, additional dyeing steps and hydrolysis steps may be utilized until the desired dye penetration or color is attained by the substrate. It may also be desirable to dry the dyed substrate prior to hydrolyzing. Thus, in some embodiments, the substrate is dyed as described herein, dried, and hydrolyzed as described herein. In some embodiments, the dyeing step is repeated 1 to about 50, 2 to about 30, 5 to about 25, 10 to about 20, or 1 to about 2, 3, 4, 5, 6, 7, 8, 9, 10, 11, 12, 13, 14, 15, 16, 17, 18, 19, 20, 21, 22, 23, 24, or 25 times. Similarly, the hydrolysis step may be repeated the same number of times that the dyeing step is repeated. In some embodiments, the hydrolysis is repeated 1 to about 50, 2 to about 30, 5 to about 25, 10 to about 20, or 1 to about 2, 3, 4, 5, 6, 7, 8, 9, 10, 11, 12, 13, 14, 15, 16, 17, 18, 19, 20, 21, 22, 23, 24, or 25 times.

Following dyeing and hydrolyzing, the substrate may be rinsed using techniques known to those skilled in the art. Similarly, the rinsing step may be performed between one or more of the dyeing and hydrolyzing steps. Preferably, one or more rinsing steps are performed after all dyeing and hydrolyzing steps are complete. However, in embodiments where the hydrolysis is performed using heat, such as an iron, hot air, or steam, a rinsing step may not be required. In situations where a rinsing step is performed, it may be is repeated 1 to about 50, 2 to about 30, 5 to about 25, 10 to about 20, or 1 to about 2, 3, 4, 5, 6, 7, 8, 9, 10, 11, 12, 13, 14, 15, 16, 17, 18, 19, 20, 21, 22, 23, 24, or 25 times.

Desirably, the rinsing is performed using an aqueous solution. In some embodiments, the aqueous rinsing solution contains water. In other embodiments, the aqueous rinsing solution contains water and additional components such as organic solvents including those described herein. In further embodiments, the aqueous rinsing solution comprises a neutralization agent.

The term “neutralization agent” as used herein refers to a chemical compound that neutralizes the hydrolyzing agent, if used. For example, the neutralization agent adjusts the pH of the dyed substrate to a pH of about 5 to about 9, e.g., about 6 to about 8, about 6 to about 7, about 6, 6.5, 7, 6.5 7, 7.5, 8, 8.5, or 9. In some examples, the neutralization agent is an acid or a base, as determined by the pH of the rinsate solution. In other examples, the neutralization agent is an acid such as acetic acid. In further examples, the neutralization agent is a base such as ammonia. In still other examples, the neutralization agent is pH adjusted water. In further embodiments, the aqueous rinsing solution contains buffering agent.

The dyeing is performed until the desired color of the substrate is reached. The desired color may be determined by one skilled in the art using techniques and instruments such as color spectrophotometers.

Before the substrate is again contacted with the dye solution, however, it may be desirable to rinse the thio-indigo-dyed substrate to remove any residual hydrolyzing agent.

Removal of residual hydrolyzing agent serves to prevent contamination of the dye solution with the hydrolyzing agent, which would decrease the effectiveness of the dye bath. Accordingly, in some embodiments, the process may include a third step, the third step being rinsing the thio-indigo dyed yarn to remove any residual hydrolyzing agent. The rinsing step may comprise simply contacting the thio-indigo-dyed yarn with water. Alternatively, where an alkali hydrolyzing agent is employed, the rinsing step may comprise contacting the thio-indigo-dyed yarn with an agent that is capable of neutralizing the hydrolyzing agent, such as a mildly acidic agent.

In some embodiments, hydrolyzing the modified thio-indigo compound may comprise subjecting the dye-treated substrate to a heat treatment at an elevated temperature. For example, the dye-treated substrate may be subjected to elevated temperatures of greater than 60° C., alternatively greater than 80° C., alternatively greater than 100° C. It is noted that the substrate itself need to obtain the stated temperature, but rather that the substrate be subjected to the elevated temperature for a period of time sufficient to bring about conversion of the modified thio-indigo compound into thio-indigo. To increase the speed at which hydrolysis occurs, the heat treatment may also comprise contacting the dye-treated yarn with a moisture-rich atmosphere. For example, in some embodiments the dye-treated yarn may be contacted with steam. The application of heat (and optionally moisture, e.g. steam) to the dye-treated yarn triggers the hydrolysis of the modified thio-indigo compound, decreasing the time necessary for conversion to thio-indigo to occur. In some embodiments, for example, the application of heat (e.g. air heat, contact heat, etc.) and optionally moisture may be controlled to convert the modified thio-indigo compound into thio-indigo in less than fifteen minutes, alternatively less than ten minutes, alternatively less than eight minutes, alternatively less than six minutes, alternatively less than five minutes, alternatively less than three minutes.

The dyeing of a cotton yarn by the improved process disclosed herein may be performed by a variety of dyeing methods. In some embodiments, for example, the dyeing may be performed using a modified dipping process. The modified dipping process may be performed in largely the same manner as the conventional dipping process that is employed for the thio-indigo dyeing of cotton yarns. In this process, one or more yarns continuously travel such that each yarn enters a dye bath at a first end and exits the dye bath at the second end. This process is known as dipping. The length of time that a particular portion of the yarn spends in the dye bath may be carefully controlled to provide for a desirable uptake of the thio-indigo precursor. The one or more yarns may continuously travel through a series of dye baths and subsequent air exposures in order to obtain a desired shade of thio-indigo.

In embodiments of the present process, the dye bath may generally comprise an aqueous solution of the modified thio-indigo compound. In addition to water and the modified thio-indigo compound, the dye bath may also contain one or more of the following: wetting agents, thickening agents, chelating agents, pH buffering agents, and stabilizers. Notably, as described above, in many embodiments the dye bath containing the modified thio-indigo compound may not contain a reducing agent. In some embodiments, therefore, the dye bath may consist essentially of water and the modified thio-indigo compound. Additionally, because the modified thio-indigo compound does not require strong reducing agents and a high pH environment to maintain stability, embodiments of the dye bath may have a pH of less than 9, alternatively less than 8, alternatively less than 7. In some embodiments, it may be desirable that the dye bath be about neutral, i.e. have a pH of about 7.

Additionally, rather than simply exposing the dye-treated yarns to air, the dye-treated yarn may be subjected to a treatment that is effective to more efficiently convert the modified thio-indigo compound into thio-indigo, such as those described herein. Importantly, the one or more yarns may continuously through a series of dye baths in order to obtain a desired shade of thio-indigo in much the same way as in the conventional process.

In some embodiments, the dyeing may be performed by a foam-dyeing process, in which a foam containing the modified thio-indigo compound may be contacted with a yarn as the yarn travels through a dyeing chamber. Because of the oxygen stability of embodiments of the modified thio-indigo compounds, the atmosphere in the dyeing chamber may contain oxygen.

For instance, in some embodiments, the dyeing chamber may contain air. It is also possible to carefully control the depth of the dye penetration into the yarn using the foam dyeing process.

In other embodiments, the dyeing may be performed by alternative methods, such as by spraying, painting, brushing, rolling, and/or printing the dye (e.g. an aqueous solution containing the modified thio-indigo compound) onto the yarn. In some embodiments, dyeing is performed using spraying. In further embodiments, dyeing is performed using painting. In other embodiments, dyeing is performed using brushing. In still further embodiments, dyeing is performed using rolling. In yet other embodiments, dyeing is performed using printing such as digital printing or screen printing.

In some embodiments, the substrate such as cotton yarn may be pre-treated with a caustic or cationic agent prior to being contacted with the dye containing the modified thio-indigo compound. The particular caustic or cationic agent may be readily selected by one skilled in the art from such reagents that may be utilized to prepare the substrate for dyeing. Examples of caustic agents that might be used in such a pre-treatment include inorganic alkalis, such as hydroxides such as sodium hydroxide, or potassium hydroxide, carbonates such as sodium carbonate, and the like, and organic alkalis, including members of the amine family such as diethanolamine, trimethylamine, hexamethylenediamine, liquid ammonia, and the like, or combinations thereof. Examples of cationic agents that might be used in such a pretreatment include diallyldimethylammonium chloride (DADMAC), polymerized diallyldimethylammonium chloride (Poly-DADMAC), [2-(acryloyloxy)ethyl]trimethylammonium chloride (AOETMAC), 3-chloro-2-hydroxylpropyl trimethyl-ammonium chloride (CHPTAC, Quat 188), and the like, or combinations thereof.

It has been found that such a pre-treatment allows for a consistent and desirable ring dyeing effect. Cotton yarns that are used to prepare denim fabrics are generally “ring dyed”, such that the core of each of the yarns remains undyed, i.e. generally white. In this way, abrasion and/or wear of a denim fabric exposes the core of yarns that make up the fabric in the region of abrasion and/or wear, providing a characteristic fading effect that is desirable in denim garments.

In order to avoid dyeing of the core, the concentration of the dye and length of contact time used in the dyeing of cotton yarns must typically be minimized. By pre-treating the cotton yarns as described herein, however, the yarns may be (a) contacted with a dye having a relatively high concentration of modified thio-indigo compound, (b) contacted with the dye for a relatively long period of time, or (c) a combination thereof, without the core of the yarn being dyed.

### V. KITS CONTAINING THE COMPOUND

Also provided are kits comprising one or more dye compound described herein and a reagent or device that converts the compound to thio-indigo. Advantageously, because the above-described compounds are stable in a dried state, they can more easily be transported and/or stored for future use.

In some embodiments, the reagent that converts the compound to thio-indigo is a base. In other embodiments, the reagent that converts the compound to thio-indigo is a device that generates heat. In other embodiments, the reagent that converts the compound to thio-indigo is a device that generates steam.

It can be seen that the described embodiments provide unique and novel modified thio-indigo compounds and a unique and novel process for dyeing a substrate, such as cotton yarn, using modified thio-indigo compounds, each of which having a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

### VI. ASPECTS

### Aspect 1

A dye compound for use in dyeing a substrate, the dye compound comprising a thio-indigo derivative, or a salt thereof, having one or more modification over the chemical structure of thio-indigo, wherein the thio-indigo derivative has a water-solubility of greater than 0.2% w/v in the absence of a reducing agent and in the presence oxygen, and converts to thio-indigo upon removing the modification, wherein the chemical structure of thioindigo is the following:

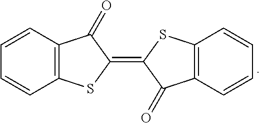 [SMILES: O=C1/C(=C2\Sc3ccccc3C2=O)Sc2ccccc21]

### Aspect 2

The dye compound of Aspect 1, wherein the dye compound is not thio-indigo.

### Aspect 3

The dye compound of Aspect 1, wherein the one or more modification enhances the aqueous solubility of the dye compound lacking the modification.

### Aspect 4

The dye compound of any one of the preceding Aspects, wherein the one or more modification is a substituent on thio-indigo or the thio-indigo derivative.

### Aspect 5

The dye compound of Aspect 4, wherein the substituent is on one or more carbon atom.

### Aspect 6

The dye compound of Aspect 4 or 5, wherein the substituent is on one more both oxygen atoms.

### Aspect 7

The dye compound of any one of Aspects 4-6, wherein the substituent is an alkyl, cycloalkyl, alkoxy, halide, acyl, amine, ester, amide, aryl, heteroaryl, heterocyclyl, sulfonate, carbamate, urea, imine, oxime, anhydride, CN, NO₂, mesylate, or tosylate, wherein each is optionally substituted.

### Aspect 8

The dye compound of any one of Aspects 1-7, wherein the reducing agent is sodium hydrosulfite, formamidine sulfinic acid, glucose, sodium borohydride, sodium metabisulfite, thiourea dioxide, cellobiose, glyceraldehyde, or fructose.

### Aspect 9

A compound which is of formula (I), (II), or (III):

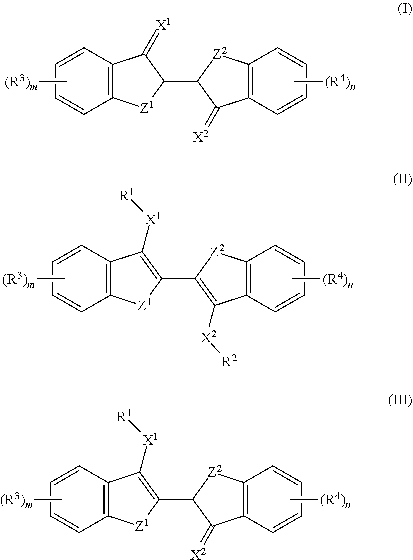

wherein:
   X¹ and X² are, independently, O, S, or Se;
   Z¹ and Z² are, independently, NR⁵, S, Se, or O;
   R¹, R², and R⁵ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆ hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl);
      R^{A} and R^{B} are, independently, H or optionally substituted C₁₋₆alkyl, or optionally substituted aryl;
      R^{C} is H, optionally substituted C₁₋₆alkyl, optionally substituted C₃₋₈cycloalkyl, optionally substituted aryl, optionally substituted heteroaryl, or optionally substituted heterocyclyl;
   R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H;
   m and n are, independently, 0 to 4;
   wherein:
   both X¹ and X² are not O when Z¹ and Z² are S;
   both X¹ and X² are not O when Z¹ and Z² are NR;
   both X1 is O, Z¹ is NH, X² is 0, and Z² is S;
or a salt thereof.

### Aspect 10

The compound of any one of the preceding Aspects, which is of formula (I-A), (I-B), or (I-C):

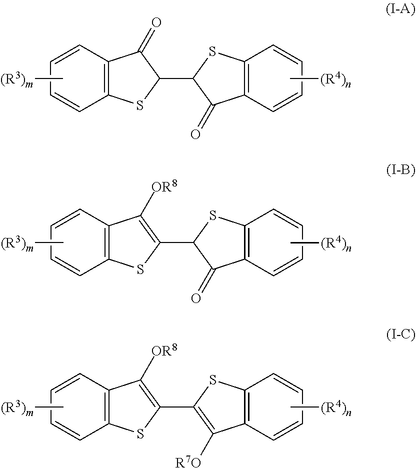

wherein:
   R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H;
   R⁷ and R⁸ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆ hydroxyalkyl), C(O)O-(optionally substituted heteroaryl), or C(O)O-(optionally substituted heterocyclyl);
   R^{A} and R^{B} are, independently, H or optionally substituted C₁₋₆alkyl, or optionally substituted aryl;
   R^{C} is H, optionally substituted C₁₋₆alkyl, optionally substituted C₃₋₈cycloalkyl, optionally substituted aryl, optionally substituted heteroaryl, or optionally substituted heterocyclyl;
   m and n are, independently, 0 to 4;
   or a salt thereof.

### Aspect 11

The compound of Aspect 10, wherein when the compound is of Formula (I-A), both R³ and R⁴ are not H.

### Aspect 12

The compound of Aspect 10 or 11, wherein one or m or n is 0.

### Aspect 13

The compound of Aspect 10 or 11, wherein R³ is a halide.

### Aspect 14

The compound of any one of Aspects 10, 11, or 13, wherein R⁴ is a halide.

### Aspect 15

The compound of any one of Aspects 10, 11, or 14, wherein R³ is C₁₋₆alkyl.

### Aspect 16

The compound of any one of Aspects 10, 11, 14, or 15, wherein R⁴ is C₁₋₆alkyl.

### Aspect 17

The compound of any one of Aspects 10-16, wherein one or both of R⁷ and R⁸ are H.

### Aspect 18

The compound of any one of Aspects 10-16, wherein one of R⁷ and R⁸ are SO₃H.

### Aspect 19

The compound of any one of Aspects 10-16, wherein one or both of R⁷ and R⁸ are C(O)(optionally substituted heteroaryl) such as C(O)(optionally substituted pyridyl).

### Aspect 20

The compound of any one of Aspects 10-16, wherein one or both of R⁷ and R⁸ are C(O)(optionally substituted C₁₋₆alkyl).

### Aspect 21

The compound of Aspect 20, wherein the C₁₋₆alkyl is substituted with C(O)O(C₁₋₆ alkyl) such as C(O)OCH₂CH₃.

### Aspect 22

The compound of any one of Aspects 10-16, wherein one or both of R⁷ and R⁸ are C(O)-(optionally substituted aryl) such as C(O)-(optionally substituted phenyl).

### Aspect 23

The compound of Aspect 22, wherein the phenyl is substituted with CO₂H.

### Aspect 24

The compound of Aspect 9 which is of formula (II-A), (II-B), or (II-C) or a salt thereof:

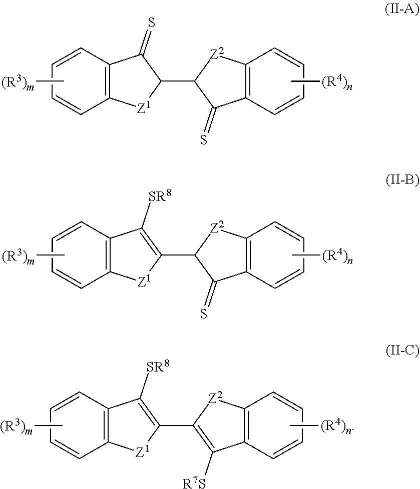

### Aspect 25

The compound of Aspect 9 which is of formula (III-A), (III-B), or (III-C) or a salt thereof:

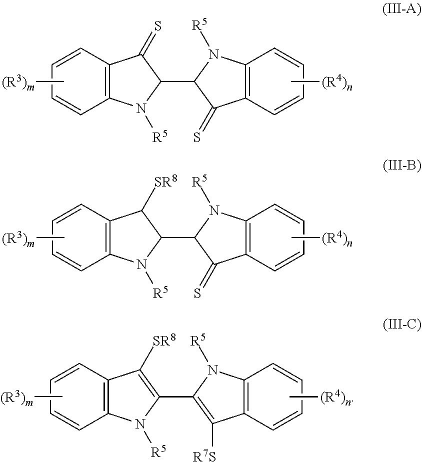

### Aspect 26

The compound of Aspect 9 which is of formula (IV-A), (IV-B), or (IV-C) or a salt thereof:

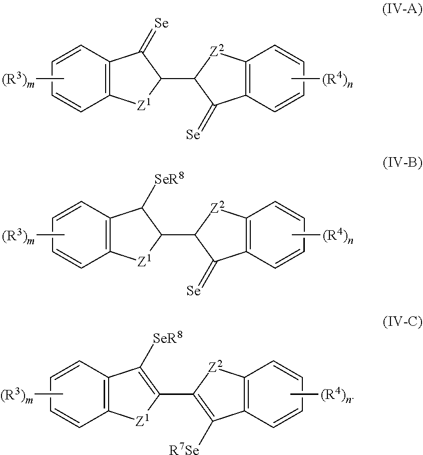

### Aspect 27

The compound of Aspect 9 which is of formula (V-A), (I-B), or (V-C) or a salt thereof:

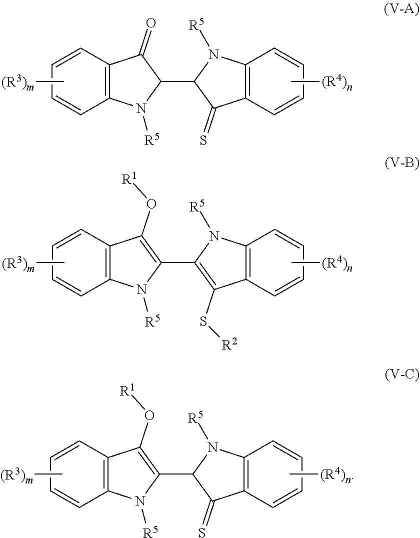

### Aspect 28

The compound of Aspect 9, which is of formula (VI-A), (VI-B), or (VI-C):

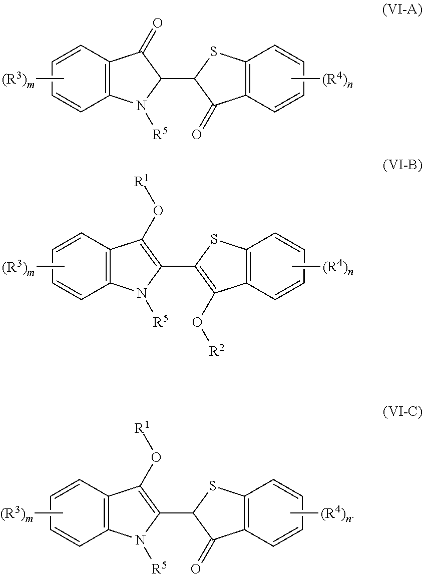

### Aspect 29

The compound of Aspect 9, which is of formula (VII-A), (VII-B), or (VII-C):

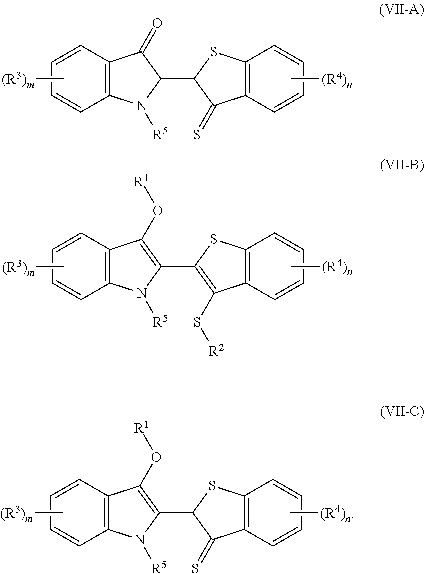

### Aspect 30

The compound of Aspect 9, which is of formula (VIII-A), (VIII-B), or (VIII-C):

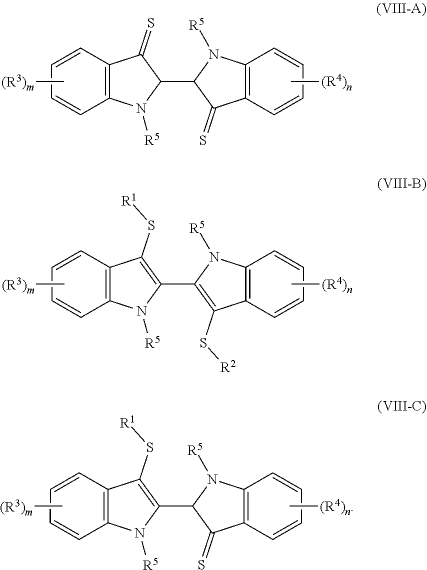

### Aspect 31

The compound of Aspect 9, which is of formula (IX-A), (IX-B), or (IX-C):

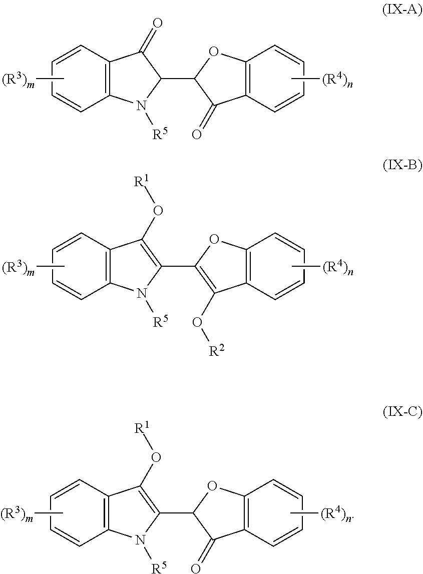

### Aspect 32

The compound of Aspect 9, which is of formula (X-A), (X-B), or (X-C):

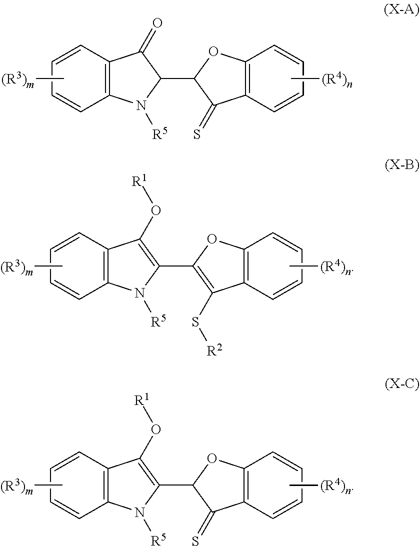

### Aspect 33

The compound of any one of the preceding Aspects which is an acid or base addition salt.

### Aspect 34

The compound of any one of the preceding Aspects, which is a sulfate salt, alkylsulfate salt, bisulfate salt, phosphate salt, or halide salt.

### Aspect 35

The compound of Aspect 28, wherein the halide salt is an iodide salt, chloride salt, bromide salt, or fluoride salt.

### Aspect 36

The compound of Aspect 28, which is an alkylsulfate salt.

### Aspect 37

The compound of Aspect 30, which is a methylsulfate or ethylsulfate salt.

### Aspect 38

The compound of Aspect 1, that is:

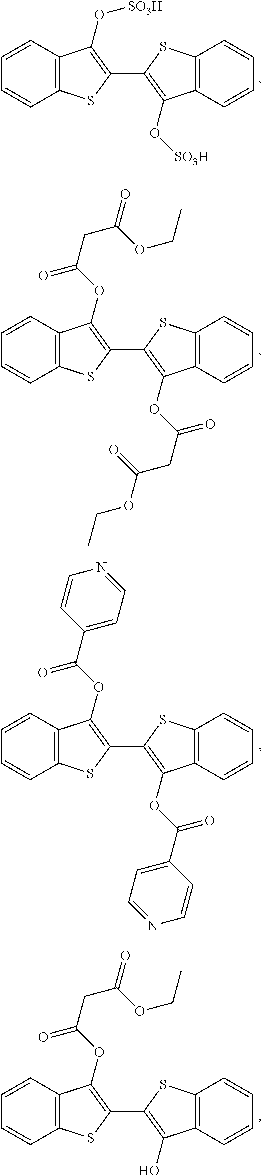

or a salt thereof.

### Aspect 39

The compound of any one of the preceding Aspects, which converts to the leuco form of the compound through hydrolysis, such as using a hydrolyzing agent, heat, steam, or combinations thereof.

### Aspect 40

The compound of any one of the preceding Aspects, which has greater water solubility than the leuco form of the compound.

### Aspect 41

The compound of any one of the preceding Aspects, which is substantially stable in the presence of oxygen such as in aqueous solutions.

### Aspect 42

A composition comprising (i) a compound of any one of the preceding Aspects and (ii) water.

### Aspect 43

The composition of Aspect 42, further comprising one or more of an acid, cationic agent, chelating agent, color retention agent, coloring agent, dispersant, foaming agent, mercerization reagent, penetration enhancer, pH buffering agent, salt, solubilizing agent, stabilizing agent, surfactant, thickening agent, tracer, viscosity modifier, or wetting agent.

### Aspect 44

A kit comprising:
   (i) one or more compound of any one of Aspects 1-39; and
   (ii) a reagent and/or device that converts the compound to thio-indigo.

### Aspect 45

The kit of Aspect 44, wherein reagent (ii) comprises a base, a device that generates heat, or a device that generates steam.

### Aspect 46

A method of preparing a bath for dyeing a substrate, comprising mixing a compound of any one of Aspects 1-39 with water.

### Aspect 47

The method of Aspect 46, wherein the water is acidic.

### Aspect 48

The method of Aspect 46 or 47, wherein the water further comprises one or more additional components.

### Aspect 49

The method of Aspect 48, wherein said additional component is an acid, cationic agent, caustic agent, chelating agent, color retention agent, coloring agent, dispersant, foaming agent, hydrolyzing agent, mercerization reagent, penetration enhancer, pH buffering agent, salt, solubilizing agent, stabilizing agent, surfactant, thickening agent, tracer, viscosity modifier, or wetting agent.

### Aspect 50

A method of dyeing a substrate, comprising:
   (i) contacting the substrate with a compound of any one of Aspects 1-39; and
   (ii) hydrolyzing the compound of step (i).

### Aspect 51

The method of Aspect 50, further comprising repeating steps (i) and (ii).

### Aspect 52

The method of Aspects 51 or 51, wherein the contacting comprises an aqueous bath.

### Aspect 53

The method of Aspect 52, wherein the aqueous bath comprises one or more of an acid, cationic agent, chelating agent color retention agent, coloring agent, dispersant, foaming agent, mercerization reagent, pH buffering agent, penetration enhancer, salt, stabilizing agent such as NaCl or Na₂SO₄, solubilizing agent, surfactant, thickening agent, tracer, viscosity modifier, or wetting agent, or combinations thereof.

### Aspect 54

The method of Aspect 52 or 53, wherein the aqueous bath lacks a reducing agent to convert the compound to a leuco form of the compound.

### Aspect 55

The method of Aspect 54, wherein the reducing agent is sodium hydrosulfite, formamidine sulfinic acid, glucose, sodium borohydride, sodium metabisulfite, thiourea dioxide, cellobiose, glyceraldehyde, fructose, or combinations thereof.

### Aspect 56

The method of any one of Aspects 52-55, wherein the aqueous bath lacks an alkali agent.

### Aspect 57

The method of any one of Aspects 52-56, wherein the pH of the aqueous bath is less than about 9.

### Aspect 58

The method of any one of Aspects 52-57, wherein the aqueous bath comprises about 0.5 wt. % to about 70 wt. %, based on the weight of the bath, of the compound.

### Aspect 59

The method of Aspect 52, wherein the aqueous bath comprises about 1 wt. % to about 50 wt. %, based on the weight of the bath, of the compound.

### Aspect 60

The method of Aspect 53, wherein the bath comprises about 2 wt. % to about 30 wt. %, based on the weight of the bath, of the compound.

### Aspect 61

The method of any one of Aspects 46-60, wherein the hydrolyzing is performed using a base, heat, steam, or a combination thereof.

### Aspect 62

The method of Aspect 61, wherein the base is a hydroxide base, an alkaline earth base, or a carbonate.

### Aspect 63

The method of Aspect 62, wherein the base is a hydroxide base that is sodium hydroxide, potassium hydroxide, or lithium hydroxide.

### Aspect 64

The method of Aspect 62, wherein the base is a carbonate that is sodium carbonate or potassium carbonate.

### Aspect 65

The method of Aspect 61, wherein heat comprises a temperature of at least about 80° C. such as about 80 to about 200° C., such as about 80 to about 100° C., about 80 to about 120° C., about 80 to about 150° C., or about 80 to about 180° C.

### Aspect 66

The method of any one of Aspects 50-65, further comprising:
   (iii) rinsing the substrate from step (ii).

### Aspect 67

The method of Aspect 66, further comprising repeating steps (i) through (iii).

### Aspect 68

The method of Aspect 66 or 67, wherein rinsing is performed with an aqueous solution.

### Aspect 69

The method of Aspect 68, wherein the aqueous solution further comprises an organic solvent, acid, cationic agent, caustic agent, chelating agent, color retention agent, coloring agent, dispersant, foaming agent, hydrolyzing agent, mercerization reagent, penetration enhancer, pH buffering agent, salt, solubilizing agent, surfactant, thickening agent, tracer, viscosity modifier, or wetting agent.

### Aspect 70

The method of Aspect 68 or 69, wherein the aqueous solution further comprises a neutralization agent or buffering agent.

### Aspect 71

The method of Aspect 70, wherein the pH of the dyed substrate is adjusted to about 5 to about 9.

### Aspect 72

The method of any one of Aspects 50-71, further comprising:
   (iv) pretreating the substrate prior to step (i) with a cationic agent or caustic agent.

### Aspect 73

The method of Aspect 72, wherein the cationic agent is diallyldimethylammonium chloride, polymerized diallyldimethylammonium chloride, [2-(acryloyloxy)ethyl] trimethylammonium chloride, 3-chloro-2-hydroxylpropyl trimethyl-ammonium chloride, or a combination thereof.

### Aspect 74

The method of Aspect 72, wherein the caustic agent is sodium hydroxide, potassium hydroxide, sodium carbonate, diethanolamine, trimethylamine, hexamethylenediamine, liquid ammonia, or a combination thereof.

### Aspect 75

The method of any one of Aspects 50-74, wherein the substrate is a textile.

### Aspect 76

The method of any one of Aspects 50-74, wherein the substrate is a natural substrate such as a plant fiber such as cotton, kapok, hemp, bamboo, flax, sisal, jute, kenaf, ramie, bamboo, soybean, or coconut or an animal substrate such as silk, wool, leather, hair, or feather.

### Aspect 77

The method of any one of Aspects 50-75, wherein the substrate is a synthetic substrate such as a polyamide such as nylon, polyester, acrylic, polyolefin, or spandex.

### Aspect 78

The method of any one of Aspects 50-77, wherein the substrate is a yarn.

### Aspect 79

The method of any one of Aspects 50-78, wherein the substrate is a package of yarn.

### Aspect 80

The method of any one of Aspects 50-78, wherein the substrate is a fabric.

### Aspect 81

The method of any one of Aspects 50-80, wherein the substrate is dyed denim fabric.

### Aspect 82

The method of any one of Aspects 50-81, wherein the contacting comprises dip dyeing, rope dyeing, slasher dyeing, spray dyeing, continuous dyeing, piece dyeing, space dyeing, package dyeing, skein dyeing, garment dyeing, paint brush dyeing, airbrush dyeing, blotch dyeing, or foam dyeing.

### Aspect 83

The method of any one of Aspects 50-82, wherein the treating comprises screen printing or digital printing.

### Aspect 84

The method of any one of Aspects 50-82, wherein the bath is a foam and the foam is applied to the textile.

### Aspect 85

The method of any one of Aspects 50-84, wherein less than about 50, 45, 40, 35, 30, 25, 20, 15, 10, or 5 wt. % of the compound in an aqueous solution degrades under atmospheric conditions over a period of about 12 hours in the absence of a reducing agent.

### Aspect 86

A dyed substrate prepared according to the methods of any one of Aspects 50-85.

### VII. EXAMPLES

All UV-Vis spectra are obtained using a Varian Cary 6000i UV-Vis spectrophotometer.

### Example 1: Synthesis of Compound 1

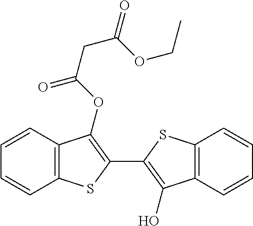 [SMILES: CCOC(=O)CC(=O)Oc1c(-c2sc3ccccc3c2O)sc2ccccc12]

To a suspension of thio-indigo in anhydrous ethyl acetate containing sodium acetate and zinc was added ethyl malonyl chloride. The reaction mixture stirs for 30 mins at 40° C. The suspension cools to room temperature and concentrates to dryness. The residue is extracted with hot acetone. The crude material is purified using flash column chromatography eluting with 20% ethyl acetate: pet ether. The product is isolated.

### Example 2: Synthesis of Compound 2

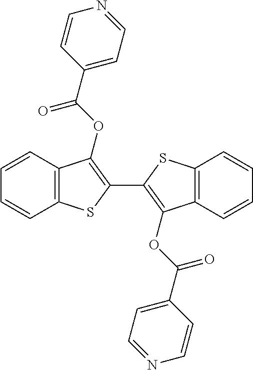 [SMILES: O=C(Oc1c(-c2sc3ccccc3c2OC(=O)c2ccncc2)sc2ccccc12)c1ccncc1]

To a suspension of thio-indigo in anhydrous ethyl acetate containing sodium acetate and zinc is added isonicotinoyl chloride. The reaction mixture is allowed to stir for 30 mins at 40° C. The suspension is allowed to cool to room temperature and then concentrated to dryness.

The residue is extracted with hot acetone. The crude material is purified using flash column chromatography eluting with 20% ethyl acetate: pet ether. The product is isolated.

### Example 3: Synthesis of Compound 3

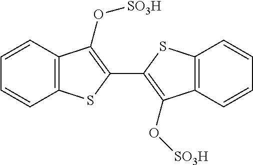 [SMILES: O=S(=O)(O)Oc1c(-c2sc3ccccc3c2OS(=O)(=O)O)sc2ccccc12]

To a suspension of thio-indigo in anhydrous ethyl acetate containing sodium acetate and zinc is added chlorosulfonic acid. The reaction mixture is allowed to stir for 30 mins at 40° C. The suspension is allowed to cool to room temperature and then filtered to remove zinc. The filtrate is concentrated to dryness.

### Example 4: Synthesis of Compound 4

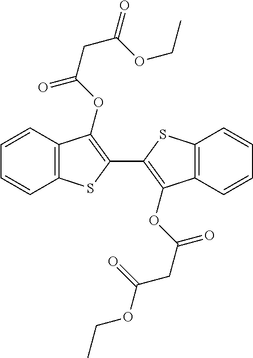 [SMILES: CCOC(=O)CC(=O)Oc1c(-c2sc3ccccc3c2OC(=O)CC(=O)OCC)sc2ccccc12]

To a suspension of thio-indigo in anhydrous ethyl acetate containing sodium acetate and zinc is added ethyl malonyl chloride. The reaction mixture is allowed to stir at 40° C. for at least 1 hour. The suspension is allowed to cool to room temperature and then concentrates to dryness. The residue is extracted with hot acetone. The crude material is purified using flash column chromatography eluting with 20% ethyl acetate: pet ether.

### Example 5: Storage Stability

(a) Test 1

The stability of compounds 1-4 is measured by diluting samples of the compound in water to provide 0.01 and 3% wt. % solutions. The solutions are then stored at room temperature for 5 days. The UV-Vis spectra of the solutions after 1, 2, and 5 days are obtained.

(b) Test 2

The longer term stability of compounds 1-4 is measured by diluting a sample of each compound in water to provide a 0.01 wt. % solution containing 0.1M NaCl (aq). The solution is then stored at room temperature for 5 days. The UV-Vis spectra of the solution are obtained daily over the 5 days.

(c) Test 3

The stability and concurrent dyeing ability of compounds 1-4 is evaluated.

Specifically, the UV-Vis spectra are taken over 3 days for an aqueous solution containing 0.6 wt. % of the compound stored at room temperature. For each time point, a small aliquot of the dye solution is removed and diluted by a factor of 60 with water to collect the UV-Vis spectrum.

Prior to collecting the UV-Vis data, the solution is used to dye a cotton skein.

(d) Test 4

Aqueous solutions of 2 wt. % of compounds 1-4 are prepared with varying concentrations of sodium sulfate and then filtered through a 0.45 micron PVDF syringe filter after one day of room temperature storage. The filters are then dried at 120° C., cooled to room temperature, and weighed to quantify the amount of insoluble solids that may precipitate out of solution during storage.

In a control experiment, the weight change (−0.35%) is determined for a syringe filter that was flushed with 10 mL distilled water and then dried at 120° C.

### Example 6: Air Stability

The air stability of compounds 1-4 are measured by diluting the compound in water to provide a 0.01 wt. % solution. The solution is then stored for 1 day at 8° C. under different conditions to examine air stability. The UV-Vis spectra of the solutions are obtained.

### Example 7: Relative Kinetics

In this example, the relative kinetics of degradation for two conditions for the compounds are measured. One solution contains 0.01 wt. % Compound land 0.1M NaCl aqueous and the other solution contains 0.01 wt. % of Compound 1. Both solutions are stored at room temperature and the hydrolysis monitored using UV-Vis spectrophotometry.

### Example 8: Dyeing of Woven Cotton Fabric

A 3×1 twill cotton fabric is woven using package-dyed yarns that are dyed using an aqueous solution containing 3 wt. % of Compound 1. Specifically, the package is rinsed with water, treated with an aqueous solution containing 3 wt. % of Compound 1, hydrolyzed with 1 M NaOH(aq), and then rinsed with water.

### Example 9: Dyeing of Polyester

Polyester yarns are dyed with either an aqueous solution containing 3 wt. % of Compound 1 or with a thio-indigo solution containing 0.2 wt. % thio-indigo, 0.5 wt. % NaOH, and 0.5 wt. % sodium hydrosulfite that was previously heated to 50-60° C. for 30 minutes, and allowed to cool to room temperature, hydrolyzed using 1 M NaOH (aq), and rinsed. The dyed polyester yarns are then subjected to 1 cycle 2A AATCC washfastness tests as described in the AATCC Technical Manual, American Association of Textile Chemists and Colorists, Vol. 91, pages 1-510, 2016, which is herein incorporated by reference, which are equivalent to five home laundries. The yarns dyed using indigo are then skied and rinsed.

### Example 10: Polyester vs. Cotton Dyeing

Polyester and cotton knitted socks are dyed with Compound land then washed in one home laundry. The socks are dyed as follows: (1) pre-wetting with water, (2) submersion in a 3 wt. % aqueous dye bath of Compound 1, (3) hydrolysis in 1 M NaOH (aq), and (4) rinsing with water.

### Example 11: Color Measurements

International Commission on Illumination (CIE) L*a*b* color measurements are obtained for cotton skeins dyed with solutions of Compounds 1-4 using a Hunterlabs Benchtop Spectrophotometer. See, e.g., Color Technology in the Textile Industry, Second Edition, American Association of Textile Colorists and Chemists, 1997. Individual aqueous solutions containing 3 wt. % of each compound are prepared. Scoured and unscoured cotton skeins are then dyed using the procedure of Example 10 and the colors of each skein measured.

### Example 12: Cotton Fabric Dyeing with Heat Treatment

Prepared for dye (PFD) 3×1 twill cotton fabric dyed with Compound 1 are prepared by dipping in an aqueous solution containing 3 wt. % of a compound, padding, and drying at 50° C. The samples are then placed separately into a lab-scale tenter frame for heat treatment.

### Example 13: Cotton Fabric Dyeing with Heat Treatment and Pretreatment

Cotton skeins are pretreated with 1 M NaOH (aq), dyed with a 3 wt. % aqueous solution of Compound 1, hydrolyzed using 1 M NaOH (aq), and then rinsed with water. The skeins are then dried at 50° C.

### Example 14: Air Brushing

PFD 3×1 twill cotton fabric is air-brushed with the aid of a mask using a 3 wt. % aqueous solution of Compound 1. Following drying at 50° C., the fabric is hydrolyzed by submersion in a 1 M NaOH (aq) bath followed by rinsing with water and drying at 50° C.

### Example 15: Shade Variation with Dip Dyeing

The depth of shade for dyed cotton skein is controlled by varying the concentration of the dye bath. The dyeing process entails (1) pretreating the cotton skein with 1 M NaOH (aq), (2) submersing in a dye bath of 10, 6, 3, or 0.5 wt. % aqueous solutions of Compound 1, (3) hydrolyzing in 1 M NaOH (aq), and (4) rinsing with water.

### Example 16: Shade Variation Using Ring-Dyeing

The depth of shade for cotton skeins is controlled by varying the concentration of the dye bath with retention of ring-dyeing. The dyeing process entails (1) pretreating with 1 M NaOH (aq), (2) submersing in a 0.6, 3, 6, or 10 wt. % aqueous dye bath of Compound 1, (3) hydrolyzing in 1 M NaOH (aq), and (4) rinsing with water.

### Example 17: Core-Dyeing of Yarns

Cotton skeins are dyed using Compound 1. The dyeing process entails (1) pre-wetting the cotton skein with water, (2) submersing the wet cotton skein in a 3 wt. % aqueous dye bath of the compound, (3) hydrolyzing in 1 M NaOH (aq), and (4) rinsing with water.

### Example 18: Consecutive Dyeing Cycles

Cotton skeins are dyed with Compound 1 over one or two consecutive dyeing cycles.

For each cycle, the process entails (1) pretreating with 1 M NaOH (aq), (2) submersing in a 3 wt. % dye bath of aqueous Compound 1, (3) hydrolyzing in 1 M NaOH (aq), and (4) rinsing with water.

### Example 19: Ring-Dyeing from Rope Dyeing Experiments

Ring-dyed cotton ropes dyed with Compound 1 are prepared using a lab-scale Roaches SkyPad rope-dyeing instrument. The cotton ropes are passed through a series of baths at a rate of 0.8-3.2 meters/minute and padded in between (about 50% wet pickup). The process entails (1) pretreating with 1 M NaOH (aq), (2) submersing in an aqueous 3 wt. % Compound 8, (3) hydrolyzing in 1 M NaOH (aq), and (4) rinsing with water. The dyed ropes are then rinsed extensively with water followed by drying in an oven at 60° C.

### Example 20: Solubility Studies

The solubility of Compounds 1-4 is measured in this example. The solutions are prepared by adding a known amount of dye to a known amount of water and agitating the solution. Separately, each solution of known concentration is centrifuged for 30 minutes to separate out any undissolved solids. The supernatant is decanted and the remaining undissolved solids are dried at 50° C. and later weighed to determine wt. % of soluble portion.

The actual concentrations versus expected concentrations for aqueous solutions containing Compounds 1-4 are measured using solubility studies in water. The actual concentration is determined by centrifuging the dye solutions extensively to remove any undissolved solids. The undissolved solids are then isolated, dried, and weighed.

### Example 21: Screen Printing

PFD 3×1 twill cotton fabric is screen printed using a screen printing ink containing Compound 1. The ink is prepared by adding an aqueous solution of 3 wt. % the compound to a 0.5 wt. % methylcellulose aqueous solution. Hydrolysis is carried out by spraying 1 M NaOH (aq) onto the printed area followed by rinsing with water.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. In addition to the embodiments described herein, the present invention contemplates and claims those inventions resulting from the combination of features of the invention cited herein and those of the cited prior art references which complement the features of the present invention.

Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

What is claimed is:

1. A dye compound for use in dyeing a substrate, the dye compound comprising a thio-indigo derivative, or a salt thereof, having one or more modification over the chemical structure of thio-indigo, wherein the thio-indigo derivative has a water-solubility of greater than 0.2% w/v in the absence of a reducing agent and in the presence oxygen, and converts to thio-indigo upon removing the modification, wherein the chemical structure of thioindigo is the following:

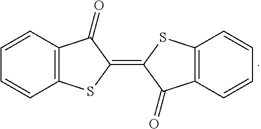 [SMILES: O=C1/C(=C2\Sc3ccccc3C2=O)Sc2ccccc21]

2. The dye compound of claim 1, wherein the dye compound is not thio-indigo.

3. The dye compound of claim 1, wherein the one or more modification enhances the aqueous solubility of the dye compound lacking the modification.

4. The dye compound of claim 1, wherein the one or more modification is a substituent on thio-indigo or the thio-indigo derivative.

5. The dye compound of claim 4, wherein the substituent is on one or more carbon atoms or on one more both oxygen atoms.

6. The dye compound of claim 4, wherein the substituent is an alkyl, cycloalkyl, alkoxy, halide, acyl, amine, ester, amide, aryl, heteroaryl, heterocyclyl, sulfonate, carbamate, urea, imine, oxime, anhydride, CN, NO₂, mesylate, or tosylate, wherein each is optionally substituted.

7. The compound of claim 1 which is of formula (I), (II), or (III): 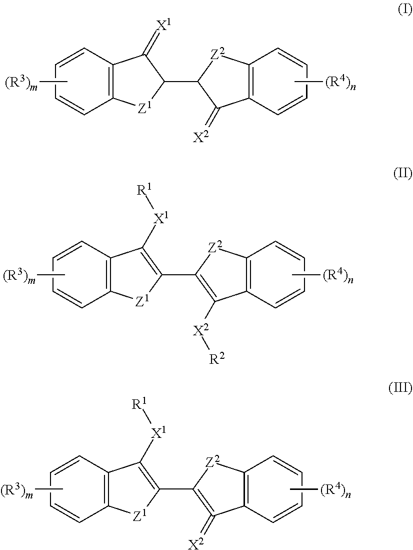
wherein:
X¹ and X² are, independently, O, S, or Se;
Z¹ and Z² are, independently, NR⁵, S, Se, or O;
R¹, R², and R⁵ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆ hydroxyalkyl), C(O)O-(optionally substituted heteroaryl), or C(O)O-(optionally substituted heterocyclyl);
R^{A} and R^{B} are, independently, H or optionally substituted C₁₋₆alkyl, or optionally substituted aryl;
R^{C} is H, optionally substituted C₁₋₆alkyl, optionally substituted C₃₋₈cycloalkyl, optionally substituted aryl, optionally substituted heteroaryl, or optionally substituted heterocyclyl;
R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H;
m and n are, independently, 0 to 4;
wherein:
both X¹ and X² are not O when Z¹ and Z² are S;
both X¹ and X² are not O when Z¹ and Z² are NR;
both X1 is O, Z¹ is NH, X² is O, and Z² is S;
or a salt thereof.

8. The compound of claim 1, which is of formula (I-A), (I-B), or (I-C): 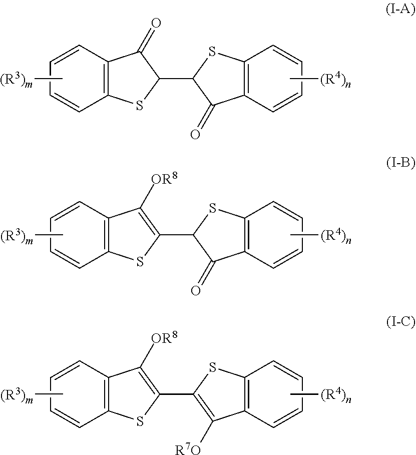
wherein:
R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H;
R⁷ and R⁸ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆ hydroxyalkyl), C(O)O-(optionally substituted heteroaryl), or C(O)O-(optionally substituted heterocyclyl);
R^{A} and R^{B} are, independently, H or optionally substituted C₁₋₆alkyl, or optionally substituted aryl;
R^{C} is H, optionally substituted C₁₋₆alkyl, optionally substituted C₃₋₈cycloalkyl, optionally substituted aryl, optionally substituted heteroaryl, or optionally substituted heterocyclyl;
m and n are, independently, 0 to 4;
or a salt thereof.

9. The compound of claim 8 which is of formula (II-A), (II-B), (II-C), (III-A), (III-B), (III-C), (IV-A), (IV-B), (IV-C), (V-A), (V-B), (V-C), (VI-A), (VI-B), (VI-C), (VII-A), (VII-B), (VII-C), (VIII-A), (VIII-B), (VIII-C), (IX-A), (IX-B), (IX-C), (X-A), (X-B), or (X-C), or a salt thereof:

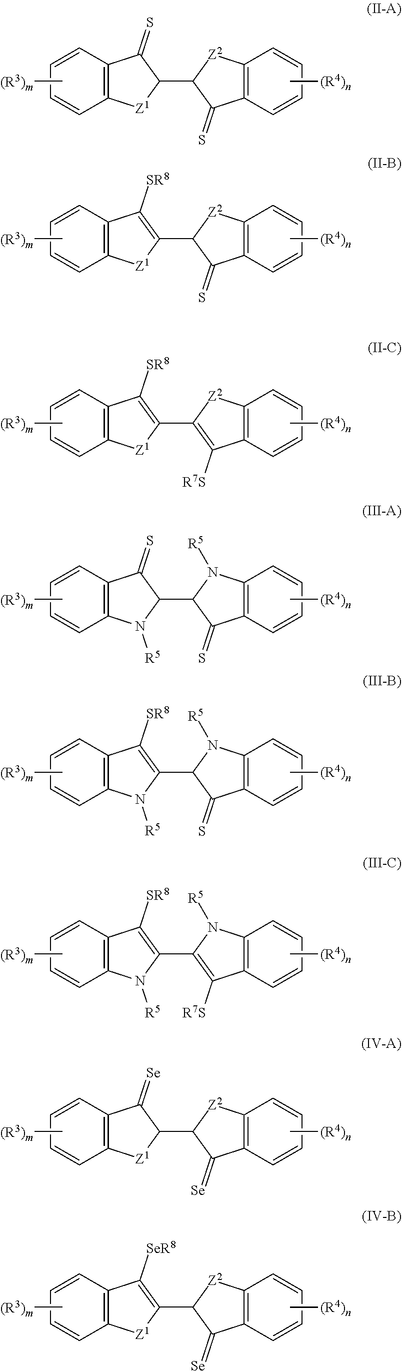

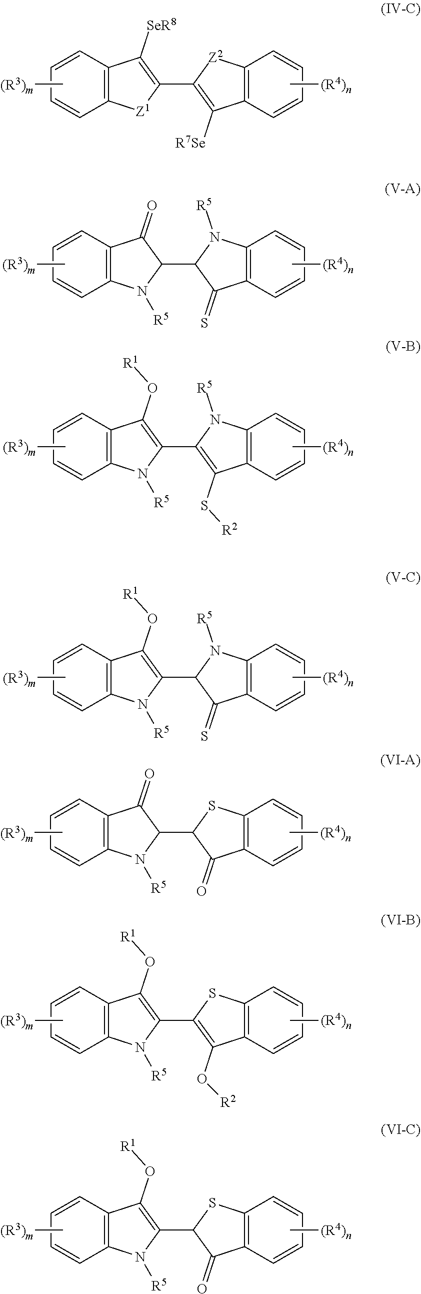

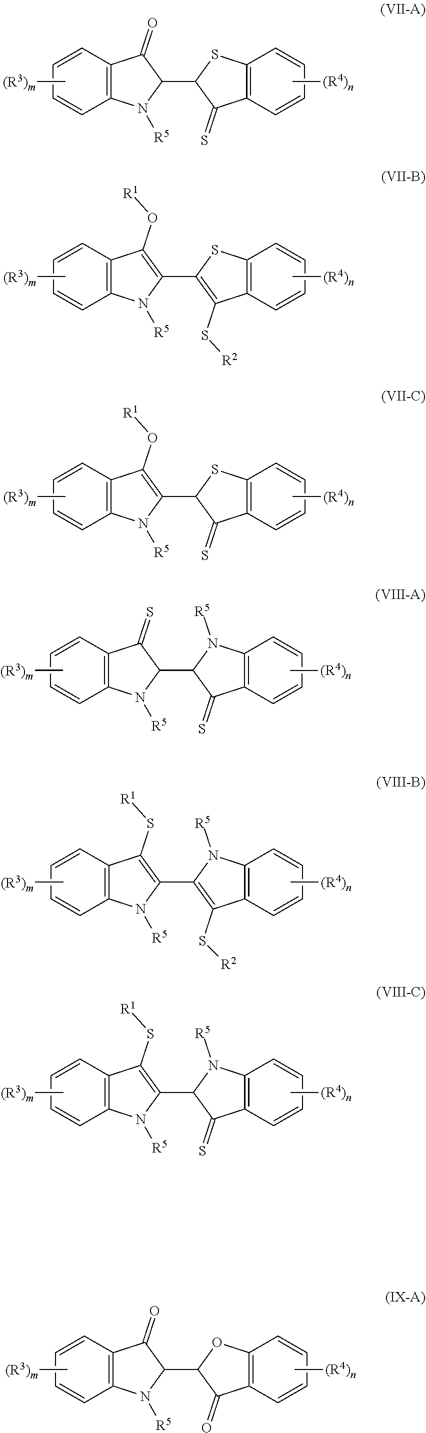

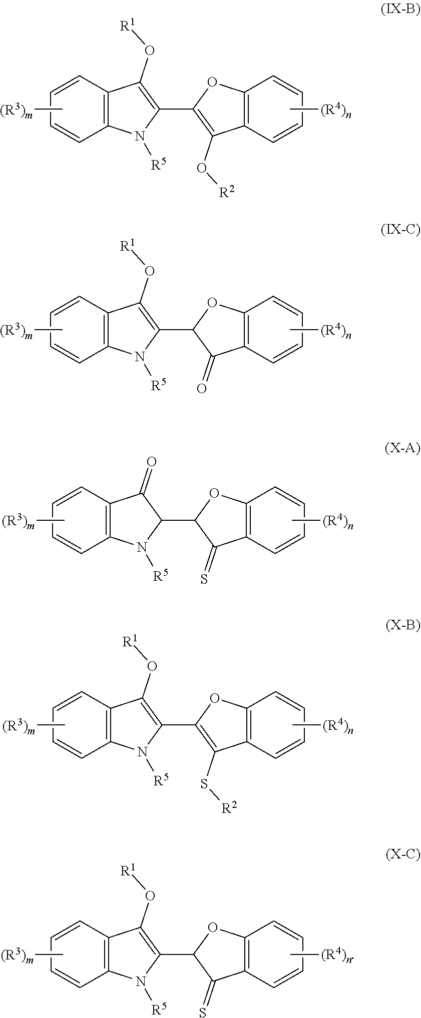

10. The compound of claim 1, that is: 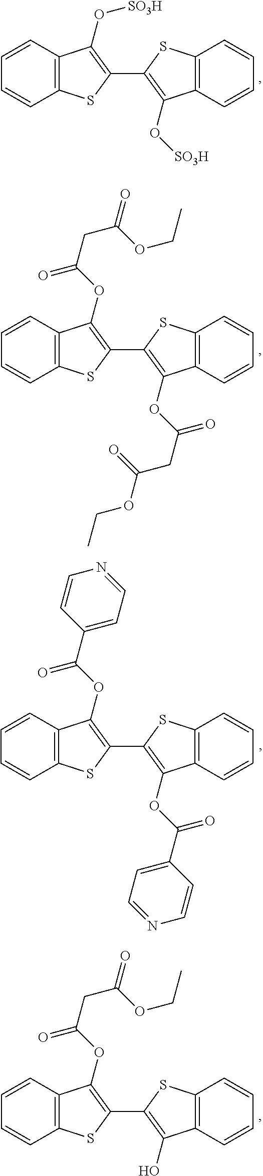
or a salt thereof.

11. The compound of claim 1, which converts to the leuco form of the compound through hydrolysis using a hydrolyzing agent, heat, steam, or a combination thereof.

12. The compound of claim 12, which has greater water solubility than the leuco form of the compound.

13. A kit comprising:
(i) one or more compound of claim 1; and
(ii) a reagent and/or device that converts the compound to thio-indigo.

14. A method of preparing a bath for dyeing a substrate, comprising mixing a compound of claim 1 with water.

15. A method of dyeing a substrate, comprising:
(i) contacting the substrate with a compound of claim 1; and
(ii) hydrolyzing the compound of step (i); and
(iii) optionally rinsing the product of step (ii).

16. The method of claim 15, wherein the contacting comprises an aqueous bath having a pH less than about 9.

17. The method of claim 16, wherein the aqueous bath lacks an alkali agent or a reducing agent to convert the compound to a leuco form of the compound.

18. The method of claim 17, further comprising:
(iv) pretreating the substrate prior to step (i) with a cationic agent or caustic agent.

19. The method of claim 17, wherein the substrate is a textile.

20. The method of claim 17, wherein less than about 50 wt. % of the compound in an aqueous solution degrades under atmospheric conditions over a period of about 12 hours in the absence of a reducing agent.
